(19) United States
(12) Patent Application Publication
(10) Pub. No.: US 2024/0355340 A1
(43) Pub. Date: Oct. 24, 2024

(54) STREAMING TECHNIQUES

(71) Applicant: FRAUNHOFER-GESELLSCHAFT ZUR FOERDERUNG DER ANGEWANDTEN FORSCHUNG E.V., Muenchen (DE)

(72) Inventors: Moritz FUCHS, Erlangen (DE); Oliver Peter MAJOR, Erlangen (DE); Ziad Marwan Daoud SHABAN, Erlangen (DE); Bernd CZELHAN, Erlangen (DE); Harald FUCHS, Erlangen (DE); Ingo HOFMANN, Erlangen (DE); Bernd HERRMANN, Erlangen (DE); Max NEUENDORF, Erlangen (DE); Stefan MELTZER, Erlangen (DE)

(21) Appl. No.: 18/758,772

(22) Filed: Jun. 28, 2024

Related U.S. Application Data
(63) Continuation of application No. PCT/EP2022/088027, filed on Dec. 29, 2022.

(30) Foreign Application Priority Data
Dec. 30, 2021 (DE) 10 2021 006 419.4

(51) Int. Cl. G10L 19/002

(52) U.S. Cl. CPC G10L 19/002

(57) ABSTRACT

A streaming client device receives a bitstream, which includes an encoded audio signal according to an encoded audio signal version selected among multiple selectable versions, each having at least one personalization option among multiple personalization options. The bitstream also includes side information with configuration information and capacity information. The streaming client device: defines a personalization, by choosing a preferred selectable version based on the capacity information and the configuration information; selects an encoded audio signal version based on a current state of the external resource and the personalization, so that the capacity required by the selected encoded audio signal version matches the current state of the external resource; and decodes the received encoded audio signal or transcodes it onto another bitstream.

### CROSS-REFERENCE TO RELATED APPLICATIONS

This application is a continuation of copending International Application No. PCT/EP2022/088027, filed Dec. 29, 2022, which is incorporated herein by reference in its entirety, and additionally claims priority from German Application No. 10 2021 006 419.4, filed Dec. 30, 2021, which is also incorporated herein by reference in its entirety.

There are disclosed streaming techniques (e.g. techniques for adaptive streaming, e.g. for a streaming server device, or a streaming client device, and streaming methods.

### BACKGROUND OF THE INVENTION

Some adaptive streaming techniques (e.g. for audio content) permit some degree of personalization, permitting the client device (e.g., under user's request) to modify some attributes of the audio content to be played back. However, personalization usually cannot go too far: indeed, some personalizations risk going against authoring, and it is not granted that there are enough authoring to fulfil all the possible personalizations, at least not at any bitrate. Therefore, when switching from a bitrate to another bitrate, the personalization may be lost, therefore reducing the quality of service. For this reason, in the case the bitrate is adaptively reduced, the streaming is often interrupted, in an attempt of preserving the personalization: also in this case quality of service is reduced, since the continuity of the provision of the steam is lost, and the playback suffers of an unwanted interruption.

### SUMMARY

According to an embodiment, a streaming client device may have: a communication interface configured to receive a bitstream from a streaming server device, the bitstream including an encoded audio signal according to an encoded audio signal version selected among a plurality of selectable encoded audio signal versions, each of the plurality of selectable encoded audio signal versions having at least one personalization audio option among a plurality of personalization audio options which is an option on an audio attribute which characterizes the particular selectable encoded audio signal version; and side information including: configuration information indicating the plurality of selectable personalization audio options for each of the selectable encoded audio signal versions; and capacity information indicating capacity required, by each of the plurality of selectable encoded audio signal versions, by an external resource, for transmitting the encoded audio signal, wherein the external resource includes, or is provided by, a communication network between the streaming server device and the streaming client device, wherein the external resource has a state which is a bandwidth at disposal of the transmission of the bitstream, wherein the capacity required by each selectable encoded audio signal version is a bitrate; a personalization unit configured to define a personalization by performing a restriction to one single preferred version for each potential state from all the capacity-matching encoded audio selectable versions, by choosing, for each of a plurality of potential states of the external resource, the preferred encoded audio signal version among the plurality of selectable encoded audio signal versions, based on both the capacity information and the configuration information, so that: for certain bandwidth(s), a particular encoded audio signal version is the preferred encoded audio signal version; and for different bandwidth(s), a different encoded audio signal version is the preferred encoded audio signal version; a selector configured to perform a selection of a selected encoded audio signal version based on a current state of the external resource and the personalization in such a way that the selected encoded audio signal version is the preferred encoded audio signal version for the current state of the external resource, so that the capacity required by the selected encoded audio signal version matches the current state of the external resource, so that the selection is not only based on the particular capacity required by each selectable encoded audio signal versions, but also on the personalization, wherein the communication interface is configured to send, to the streaming server device, a request of providing the encoded audio signal according to the selected encoded audio signal version; and a decoder configured to decode the received encoded audio signal or a transcoder configured to transcode the received encoded audio signal into another bitstream.

According to another embodiment, a streaming server device may have: a communication interface configured to: transmit a bitstream to a streaming client device, the bitstream being segmented according to a plurality of segments and having an encoded audio signal and side information, the side information including: configuration information indicating a plurality of selectable personalization audio options for each selectable encoded audio signal version of a plurality of encoded audio signal versions, wherein the configuration information indicates a set of personalization audio options offered by the other encoded audio signal versions; and capacity information indicating capacity required, by each of the plurality of selectable encoded audio signal versions, by an external resource, for transmitting the encoded audio signal, wherein the external resource includes, or is provided by, a communication network between the streaming server device and the streaming client device, wherein the external resource has a state which is a bandwidth at disposal of the transmission of the bitstream, wherein the capacity required by each selectable encoded audio signal version is a bitrate; receive requests of a selected encoded audio signal version of the bitstream, and transmit the bitstream according to the selected encoded audio signal version starting from a subsequent segment, wherein each of the encoded audio signal versions requires a predetermined capacity and offers at least one personalization audio option which is an option on an audio attribute which characterizes the particular selected encoded audio signal version, wherein the capacity is a bitrate; and a content preparation device to embed, to each encoded audio signal version, side information including capacity information indicating a capacity required for transmission of other encoded audio signal versions and configuration information indicating the at least one personalization audio option offered by the other encoded audio signal versions.

According to another embodiment, a streaming method may have the steps of: receiving a bitstream from a streaming server device, the bitstream including: an encoded audio signal according to an encoded audio signal version selected among a plurality of selectable encoded audio signal versions, each of the plurality of selectable encoded audio signal versions having at least one personalization audio option among a plurality of personalization audio options which is an option on an audio attribute which characterizes the particular selectable encoded audio signal version, and side information including: configuration information indicating the plurality of selectable personalization audio options; and capacity information indicating capacity required, by each of the plurality of selectable encoded audio signal versions, by an external resource, for transmitting the encoded audio signal, wherein the external resource includes, or is provided by, a communication network between the streaming server device and the streaming client device, wherein the external resource has a state which is a bandwidth at disposal of the transmission of the bitstream, wherein the capacity required by each selectable encoded audio signal version is a bitrate; defining a personalization by performing a restriction to one single preferred version for each potential state from all the capacity-matching encoded audio selectable versions by choosing, for each of a plurality of potential states of the external resource, a preferred encoded audio signal version among the plurality of selectable encoded audio signal versions, based on both the capacity information and the configuration information so that: for certain bandwidth(s), a particular encoded audio signal version is the preferred encoded audio signal version; and for different bandwidth(s), a different encoded audio signal version is the preferred encoded audio signal version; performing a selection of a selected encoded audio signal version based on a current state of the external resource and the personalization in such a way that the selected encoded audio signal version is the preferred encoded audio signal version for the current state of the external resource, so that the capacity required by the selected encoded audio signal version matches the current state of the external resource, so that the selection is not only based on the particular capacity required by each selectable encoded audio signal versions, but also on the personalization, sending, to the streaming server device, a request of providing the encoded audio signal according to the selected encoded audio signal version; and providing the received encoded audio signal to a decoder or a transcoder.

Another embodiment may have a streaming method for transmitting a bitstream to a streaming client device, the bitstream being segmented according to a plurality of segments and having an encoded audio signal and side information, the side information including: configuration information indicating a plurality of selectable personalization audio options for each selectable encoded audio signal version of a plurality of encoded audio signal versions, wherein the configuration information indicates a set of personalization audio options offered by the other encoded audio signal versions; and capacity information indicating capacity required, by each of the plurality of selectable encoded audio signal versions, by an external resource, for transmitting the encoded audio signal, wherein the external resource includes, or is provided by, a communication network between the streaming server device and the streaming client device, wherein the external resource has a state which is a bandwidth at disposal of the transmission of the bitstream, wherein the capacity required by each selectable encoded audio signal version is a bitrate; the method having the steps of: receiving requests of a selected encoded audio signal version of the bitstream, and transmit the bitstream according to the selected encoded audio signal version starting from a subsequent segment, wherein each of the encoded audio signal versions requires a predetermined capacity and offers at least one personalization audio option which is an option on an audio attribute which characterizes the particular selected encoded audio signal version, wherein the capacity is a bitrate; and the method including embedding, to each encoded audio signal version, side information including capacity information indicating a capacity required for transmission of other encoded audio signal versions and configuration information indicating the at least one personalization audio option offered by the other encoded audio signal versions.

In accordance to an aspect, there is provided a streaming client device, comprising:
a communication interface configured to receive a bitstream from a streaming server device, the bitstream including
   an encoded audio signal according to an encoded audio signal version selected among a plurality of selectable encoded audio signal versions, each of the plurality of selectable encoded audio signal versions addressing at least one personalization option among a plurality of personalization options,
   side information including:
      configuration information indicating the plurality of selectable personalization options; and
      capacity information indicating capacity required, by each of the plurality of selectable encoded audio signal versions, by an external resource, for transmitting the encoded audio signal;
a personalization unit configured to define a personalization by choosing, for each of a plurality of potential states of the external resource, a preferred encoded audio signal version among the plurality of selectable encoded audio signal versions, based on both the capacity information and the configuration information;
a selector configured to perform a selection of a selected encoded audio signal version based on a current state of the external resource and the personalization, so that the capacity required by the selected encoded audio signal version matches the current state of the external resource, wherein the communication interface is configured to send, to the streaming server device, a request of providing the encoded audio signal according to the selected encoded audio signal version; and
a decoder configured to decode the received encoded audio signal or a transcoder configured to transcode the received encoded audio signal onto another bitstream.

Accordingly, for each state of the external resource, the selector can select the selected encoded audio signal version for the particular current state which is the preferred encoded audio signal version for the particular state. Basically, the personalization may perform a reduction of the group of encoded audio signal versions which are actually selectable by the selector. Therefore, the selection may not only select the most adapted encoded audio signal version by keeping into consideration the required capacity, but also by taking into account further options (e.g. preselected by the user or other preselections, or anyway by the personalization unit). Therefore, the selected encoded audio signal version may be the preferred encoded audio signal version for the particular current state of the external resource (e.g. network). While for each state of the external resource there may be more than one selectable version whose capacity matches the state, for each potential state there may be one single preferred version (e.g. restricted from all the capacity-matching selectable versions), and for each current state the selected version may be the one, among the all preferred versions defined by the personalization, which matches the current state. Hence, the selector may base its selection based on the current state of the external resource and the preferred encoded audio signal version chosen by the personalization unit for the particular current state of the external resource (e.g. network).

In accordance to an aspect, the at least one selectable encoded audio signal version includes at least one deactivatable personalization option, wherein the streaming client device is configured to perform a second selection on the at least one deactivatable personalization option to select among activating and deactivating the at least one deactivatable personalization option, wherein the side information indicates that the at least one deactivatable personalization option is deactivatable.

In accordance to an aspect, the at least one selectable encoded audio signal versions includes at least two alternative personalization options which are alternative with each other, wherein the streaming client device is configured to perform a second selection among the two alternative personalization options to selectively activate one of the at least two alternative personalization options while deactivating the other(s) of the at least two alternative personalization options, wherein the side information indicates that the at least two alternative personalization options are alternative with each other.

In accordance to an aspect, the plurality of selectable encoded audio signal versions includes:
a first selectable encoded audio signal version having at least a first alternative personalization option and a second alternative personalization option alternative to the first personalization option, the first selectable encoded audio signal version requiring a first capacity at a first potential state of the external resource; and
a second selectable encoded audio signal version requiring a second capacity at a second potential state of the external resource, the second capacity being lower than the first capacity, wherein the second selectable encoded audio signal version includes the first alternative personalization option but not the second alternative personalization option,
wherein the selector is configured, in case the personalization requires the first alternative personalization option, to:
   in case of the current state of the external resource matching the first potential state of the external resource, select the first selectable encoded audio signal version, and the first alternative personalization option is chosen and decoded, rendered or transcoded, while the second alternative personalization option is deactivated;
   in case of the current state of the external resource matching the second potential state of the external resource, select the second selectable encoded audio signal version.

In accordance to an aspect, the first selectable encoded audio signal version includes more alternative personalization option than the second selectable encoded audio signal version.

In accordance to an aspect, the first alternative personalization option is defined on a first numerical range containing a second numerical range on which the second alternative personalization option is defined, or on a single numerical range on which the second alternative personalization option is defined.

In accordance to an aspect, the first selectable encoded audio signal version includes the same alternative personalization option of the second selectable encoded audio signal version, plus additional alternative personalization options.

In accordance to an aspect, the personalization unit is configured to define, for each potential state of the external resource, the personalization, through an evaluation of at least one evaluation condition on at least one personalization option, or a set or combination of personalization options, for each selectable encoded audio signal version, the evaluation providing at least one ordering to sort the selectable encoded audio signal versions according to a ranking, so as to choose the highest-ordered selectable encoded audio signal version as the preferred encoded audio signal version.

The ranking may therefore be taken into consideration by the selector, e.g. to select the preferred encoded audio signal version (e.g. the highest-ordered selectable encoded audio signal version as ordered by the personalization among the plurality of selectable encoded audio signal versions).

According to an aspect, the evaluation may be based, for example, on at least one particular numerical range.

According to an aspect, the evaluation may be performed by the personalization unit in such a way that, for each potential state of the external resource (e.g. network), personalization option(s) are evaluated. For example, for each potential state of the external resource, numerical range(s) may be evaluated.

In accordance to an aspect, the at least one evaluation condition includes at least a first evaluation condition on at least one first personalization option, or a first set or combination of personalization options, and at least one second evaluation condition on at least one second personalization option, or a second set or combination of personalization options, so as to define at least one first ordering to sort the selectable encoded audio signal versions according to the first evaluation, and one second ordering to sort the selectable encoded audio signal versions according to the second evaluation, so as to choose the preferred encoded audio signal version based on at least one of the first ordering and the second ordering.

In accordance to an aspect, the first evaluation condition is dominant, and the second evaluation condition is secondary, so as to define the preferred encoded audio signal version primarily based on the first ordering, and, in case of parity of ranking between different first-ordering-highest-ranking selectable encoded audio signal versions, to define as the preferred encoded audio signal version the first-ordering-highest-ranking selectable encoded audio signal version which has the highest ranking in the second ordering.

In accordance to an aspect, the first evaluation condition includes a condition on a dialog language, and the second evaluation condition is a condition on an at least one personalization option which is not a language.

In accordance to an aspect, there is defined an assignment of a first score from the first evaluation, and a second score from the second evaluation, so as to define a final ordering by using both the first score and the second score.

In accordance to an aspect, the first evaluation condition is a condition on the first alternative personalization option, and the second evaluation condition is a condition on the second alternative personalization option.

In accordance to an aspect, the first evaluation condition is on a first dialog language that shall be rendered, and the second evaluation condition is on a second dialog language that is potentially rendered in alternative to the first dialog language.

In accordance to an aspect, the streaming client device is configured to, in case the personalization input changes in such a way that at least one evaluation condition is still fulfilled by a currently deactivated at least one alternative personalization option, to maintain the selected version without sending a request to the streaming server device, and to change the second selection so as to fulfil the at least one evaluation condition.

In accordance to an aspect, the at least one personalization option is a preselection. In accordance to an aspect, the at least one personalization option includes the dialog of the encoded audio signal. In accordance to an aspect, the at least one option includes a gain level.

In accordance to an aspect, the at least one option includes position data. In accordance to an aspect, the at least one option includes an audio object selection. In accordance to an aspect, the at least one option is subjected to muting and unmuting of specific audio object. In accordance to an aspect, the at least one option includes mixing values for components of the encoded audio signal. In accordance to an aspect, the at least one option includes information on activation and deactivation of components of the encoded audio signal and/or information used to influence the rendering of components of the encoded audio stream. In accordance to an aspect, the personalization is obtained at least from, or conditioned at least by, a personalization input which is a user's personalization input obtained from a user interface. In accordance to an aspect, the personalization is obtained at least from, or conditioned at least by, a personalization input which includes or is based on a pre-defined setting. In accordance to an aspect, the personalization is obtained at least from, or conditioned at least by, a service provider setting. In accordance to an aspect, the personalization is obtained at least from, or conditioned at least by, a video on demand, VoD, preference. In accordance to an aspect, the personalization input in based on a choice of the at least one personalization option or set or combination of personalization audio options. In accordance to an aspect, the personalization input involves the choice of at least one evaluation condition.

In accordance to an aspect, the streaming client device is configured to output, towards the user, personalization information on the selectable encoded audio signal versions as obtained in the side information, the personalization information indicating at least one personalization audio option, so as to guide the user to define the at least one evaluation condition.

In accordance to an aspect, the streaming client device is configured to change the preferred audio signal version based on the personalization input, so as to update the request of the selected audio signal version during the reception of the bitstream, and to subsequently obtain the encoded audio signal according to the updated selected audio signal version.

In accordance to an aspect, the selector is to configured to change the selected audio signal version based on the current state of the external resource, so that the request of the selected audio signal version is updated during the reception of the bitstream, and to subsequently obtain the encoded audio signal according to the updated selected audio signal version.

In accordance to an aspect, the streaming client device is configured to perform a second selection in case a new personalization is required and in case the new personalization is satisfied by an alternative personalization option which is currently received.

In accordance to an aspect, the state on the external resource is a bandwidth at disposal of the transmission of the bitstream.

In accordance to an aspect, the external resource includes, or is provided by, the communication network between the streaming server device and the streaming client device.

In accordance to an aspect, the capacity required by each selectable encoded audio signal version includes a bitrate.

In accordance to an aspect, the encoded audio signal is segmented in a plurality of segments, wherein each segment is interchangeable with a respective segment of an encoded audio signal of at least one different encoded audio signal version.

Each segment may therefore, in examples, be self-decodable, irrespective of the other decoded segments. For example, if an immediately preceding segment has been received at a particular first capacity, a current segment may be received at a particular second capacity, different from the first capacity. Each of the first segment and the second segment may be decoded independently of each other, according to the interchangeability.

In accordance to an aspect, the streaming client device is configured to condition the selection performed by the selector and/or the personalization defined by the personalization unit by a capacity requirement conditioning information so that the selected audio signal version requires a capacity following a pre-defined data plan.

In accordance to an aspect, the streaming client device is configured to condition the selection performed by the selector and/or the personalization defined by the personalization unit by a capacity requirement conditioning information so that the selected audio signal version requires a pre-defined fast tune-in function.

In accordance to an aspect, the encoded audio signal is according to codec MPEG-H 3D Audio, wherein other selectable encoded audio signal versions are according to codec MPEG-H 3D Audio, the bitstream and/or side information being embedded according to MPEG-H 3D.

In accordance to an aspect, the encoded audio signal (or more in general a first selectable encoded audio signal version) is according to codec MPEG-H 3D Audio and/or MPEG-D USAC (Extended HE-AAC), and the other selectable encoded audio signal versions (or more in general another selectable encoded audio signal version, selectable in alternative to the first selectable encoded audio signal version) are encoded either using MPEG-H 3D Audio or MPEG-D USAC, Extended HE-AAC, wherein the bitstream or side information may be according to MPEG-H 3D Audio or MPEG-D USAC, Extended HE-AAC (or according another technique).

In accordance to an aspect, the encoded audio signal (or more in general a first selectable encoded audio signal version) is according to a first codec (e.g. MPEG-H 3D Audio), and other selectable encoded audio signal versions (or more in general other selectable encoded audio signal versions, selectable in alternative to the first selectable encoded audio signal version, e.g. for a different state of the external resource, e.g. for less bandwidth) are encoded using a second codec (e.g. MPEG-D USAC, Extended HE-AAC). (The side information may be according to MPEG-H 3D Audio or MPEG-D USAC, Extended HE-AAC, or another technique.) Therefore, it may be possible, e.g. in case the bandwidth is reduced, to switch the selection to one of the other selectable encoded audio signal versions.

In accordance to an aspect, the currently transmitted encoded audio signal (or more in general a currently transmitted selectable encoded audio signal version) is encoded using a second codec (e.g. MPEG-D USAC, Extended HE-AAC), and other selectable encoded audio signal versions (or more in general other selectable encoded audio signal versions, selectable in alternative to the first selectable encoded audio signal version, e.g. for a different state of the external resource, e.g. for more bandwidth) may be according to a first codec (e.g. MPEG-H 3D Audio). Therefore, it may be possible, e.g. in case the bandwidth is increased, to switch the selection to one of the other selectable encoded audio signal versions.

It is possible to switch from one first selected encoded audio signal version (e.g. encoded according to a first codec, e.g., NGA) which requires a higher capacity but provides more personalization options, to a second encoded audio signal version, which requires less capacity but provides less personalization options, and/or vice versa, according to the state of the external resource (e.g. network). The personalization may define that, for a first state (e.g. higher bandwidth) of the external resource, the preferred encoded audio signal version to be selected is the first encoded audio signal version provided that the capacity required by the first encoded audio signal version matches the first state, and, for a second state (e.g. lower bandwidth) of the external resource, the preferred encoded audio signal version to be selected is the second encoded audio signal version provided the capacity required by second first encoded audio signal version matches the second state. The side information (e.g., transmitted synchronously to the first encoded audio signal version) may provide configuration information (e.g. by indicating the personalization options) of the second encoded audio signal version (e.g., together with other encoded audio signal versions which require(s) less capacity than the first encoded audio signal version and which is (are) at disposal of being transmitted). Based on the received side information (and in particular on the configuration information), the personalization may be defined in such a way that a particular selectable version is chosen among the other ones, e.g. based on the personalization options (e.g. in compliance with the personalization options of the first, high capacity-requiring version). A correspondence between the personalization options (e.g. preset(s)) of the first version and the personalization options of the second versions may be defined (e.g. by the personalization unit, e.g. through the evaluation condition and/or the personalization criterion), so that the personalization options of the first version are tendentially not lost for the second version.

It is possible to switch from one first selected encoded audio signal version (e.g. encoded according to a first codec, e.g., NGA) which has at least one deactivatable personalization option and/or which gives giving the possibility of performing a local, second selection (e.g. as above), to a second encoded audio signal version (e.g. encoded according to a second codec, e.g. Extended HE-AAC, or a legacy codec), which has not deactivatable personalization options (or which has less deactivatable personalization options than the first encoded audio signal version) and/or which does not give the possibility of performing at least one second, local, selection (or which permits an inferior number of second, local selections), and/or vice versa. Under the assumption that the first encoded audio signal version requires more capacity than the second encoded audio signal version, the personalization may define that, for a first state (e.g. higher bandwidth) of the external resource (e.g. network), the preferred encoded audio signal version to be selected is the first encoded audio signal version provided that the capacity required by the first encoded audio signal version matches the first state, and, for a second state (less bandwidth) of the external resource, the preferred encoded audio signal version to be selected is the second encoded audio signal version provided the capacity required by second first encoded audio signal version matches the second state.

The personalization may define correspondences between a first encoded audio signal version (e.g. requiring more capacity and/or providing more personalization options, more second selections, and/or more deactivatable selections) and a second encoded audio signal version (e.g. requiring less capacity and/or providing less personalization options or no personalization option at all, less second selections or no second selection at all, and/or less deactivatable selections or no deactivatable selection than the first encoded audio signal version), so as to choose, as preferred encoded audio signal version whose capacity matches a second state (less bandwidth), the second encoded audio signal version and, as preferred encoded audio signal version for a first state whose capacity matches a first state (more bandwidth).

In accordance to an aspect, there is provided a streaming server device, comprising:
a communication interface configured to:
   transmit a bitstream to a streaming client device, the bitstream being segmented according to a plurality of segments and having an encoded audio signal and side information;
   receive requests of a selected audio signal version of the bitstream, and transmit the bitstream according to the selected encoded audio signal version starting from a subsequent segment, wherein each of the encoded audio signal versions requires a predetermined capacity and offers at least one personalization option; and
a content preparation device to embed, to each encoded audio signal version, side information including capacity information indicating a capacity required for transmission of other encoded audio signal versions and configuration information indicating the at least one personalization option offered by the other encoded audio signal versions.

In accordance to an aspect, the configuration information indicates a set of personalization options offered by the other encoded audio signal versions.

In accordance to an aspect, the configuration information indicates a set of alternative personalization options offered by the current and/or by the other encoded audio signal versions.

In accordance to an aspect, the encoded audio signal is according to codec MPEG-H 3D Audio, wherein other selectable encoded audio signal versions are according to codec MPEG-H 3D Audio, the bitstream and/or side information being embedded according to MPEG-H 3D.

In accordance to an aspect, the encoded audio signal is according to codec MPEG-H 3D Audio and/or MPEG-D USAC (Extended HE-AAC), wherein the encoded audio signal version is according to MPEG-H 3D Audio, and the other selectable encoded audio signal versions are encoded either using MPEG-H 3D Audio or MPEG-D USAC, Extended HE-AAC, wherein the bitstream or side information is according to MPEG-H 3D Audio or MPEG-D USAC, Extended HE-AAC.

In some examples, there may be two classes of audio codecs, NGA (New Generation Audio) and Legacy (e.g. Extended HE-AAC). NGA (Next-Generation Audio) may comprise objects and permits personalization information. Objects can be rendered into speaker-layouts, controlled by the client device. The present technique allows to manipulate objects, controlled by the client device. NGA may require a higher bitrate than Legacy, as there are more audio signals to encode. Legacy codecs can only operate on channels (speaker-layouts, see above). Legacy codecs are normally efficient at compression, but lack interactivity and personalization information. Through the present techniques, methods how NGA and Legacy can be operated in a streaming environment (e.g. DASH) in a way that allows the streaming client to switch between codec classes with minimal impact on the user experience are therefore obtained. Variations of NGA that are appropriate for the use-case are rendered into one specific channel-based version each. Metadata (e.g. configuration information) may be applied to identify the (e.g, two-way) relationship between channel-based variation and original NGA. This allows the streaming client to transition between NGA and Legacy, for example.

In accordance to an aspect, there is provided a streaming method, comprising:
receiving a bitstream from a streaming server device, the bitstream including
   an encoded audio signal according to an encoded audio signal version selected among a plurality of selectable encoded audio signal versions, each of the plurality of selectable encoded audio signal versions having at least one personalization option among a plurality of personalization options, and
   side information including:
      configuration information indicating the plurality of selectable personalization options; and
      capacity information indicating capacity required, by each of the plurality of selectable encoded audio signal versions, by an external resource, for transmitting the encoded audio signal;
defining a personalization by choosing, for each of a plurality of potential states of the external resource, a preferred encoded audio signal version among the plurality of selectable encoded audio signal versions, based on both the capacity information and the configuration information;
performing a selection of a selected encoded audio signal version based on a current state of the external resource and the personalization, so that the capacity required by the selected encoded audio signal version matches the current state of the external resource,
sending, to the streaming server device, a request of providing the encoded audio signal according to the selected encoded audio signal version; and
providing the received encoded audio signal to a decoder or a transcoder.

In accordance to an aspect, there is provided a non-transitory storage unit storing instructions which, when executed by a processor,
cause the processor to process a bitstream received from a streaming server device, the bitstream including
   an encoded audio signal according to an encoded audio signal version selected among a plurality of selectable encoded audio signal versions, each of the plurality of selectable encoded audio signal versions having at least one personalization option among a plurality of personalization options, and
   side information including:
      configuration information indicating the plurality of selectable personalization options; and
      capacity information indicating capacity required, by each of the plurality of selectable encoded audio signal versions, by an external resource, for transmitting the encoded audio signal;
the processing including:
   defining a personalization by choosing, for each of a plurality of potential states of the external resource, a preferred encoded audio signal version among the plurality of selectable encoded audio signal versions, based on both the capacity information and the configuration information;
   performing a selection of a selected encoded audio signal version based on a current state of the external resource and the personalization, so that the capacity required by the selected encoded audio signal version matches the current state of the external resource, so as control the request, to the streaming server device, of providing the encoded audio signal according to the selected encoded audio signal version; and
   controlling the provision of the received encoded audio signal to a decoder or a transcoder.

In accordance to an aspect, there is provided a streaming method for transmitting a bitstream to a streaming client device, the bitstream being segmented according to a plurality of segments and having an encoded audio signal and side information, comprising:
receiving requests of a selected audio signal version of the bitstream, and transmit the bitstream according to the selected encoded audio signal version starting from a subsequent segment, wherein each of the encoded audio signal versions requires a predetermined capacity and offers at least one personalization option; and
the method including embedding, to each encoded audio signal version, side information including capacity information indicating a capacity required for transmission of other encoded audio signal versions and configuration information indicating the at least one personalization option offered by the other encoded audio signal versions.

In accordance to an aspect, there is provided a non-transitory storage unit storing instructions which, when executed by a processor, cause the processor to process a bitstream to be transmitted to a streaming client device, the bitstream being segmented according to a plurality of segments and having an encoded audio signal and side information, the processing comprising:
after receiving requests of a selected audio signal version of the bitstream, controlling the transmission of the bitstream according to the selected encoded audio signal version starting from a subsequent segment, wherein each of the encoded audio signal versions requires a predetermined capacity and offers at least one personalization option;
wherein the processing includes embedding, to each encoded audio signal version, side information with capacity information indicating a capacity required for transmission of other encoded audio signal versions, and configuration information indicating the at least one personalization option offered by the other encoded audio signal versions.

### BRIEF DESCRIPTION OF THE DRAWINGS

Embodiments of the present invention will be detailed subsequently referring to the appended drawings, in which:

FIGS. 1a, 1b, 1c, 1d, 1e show examples of streaming client devices.

FIGS. 2a and 2b show examples of operations.

FIGS. 3a, 3b, 4a, 4b, 5a, 5b, 6a, 6b, 7 show examples of operations of a streaming client device.

FIG. 8 shows an example of side information in a bitstream.

FIG. 9 shows an example of a streaming server device.

FIGS. 10a, 10b, 10c, 10d, 10e show examples of streaming client devices.

FIGS. 11a, 11b, 11c, 12a, 12b, 13a, 13b show examples of operations.

### DETAILED DESCRIPTION OF THE INVENTION

### Examples

Here below, reference is normally made to audio content (e.g., streams, signals, etc.), and hardware and procedures to process to audio content. However, the audio content may be part of media content (e.g., including video). It is remarked that, in examples, any of the here-mentioned content (e.g., streams, signals, etc.) may be understood as being part of the media content (e.g., media streams, media signals) including therefore also video content, and hardware and procedures may be intended as processing media content including the audio content and also the video content.

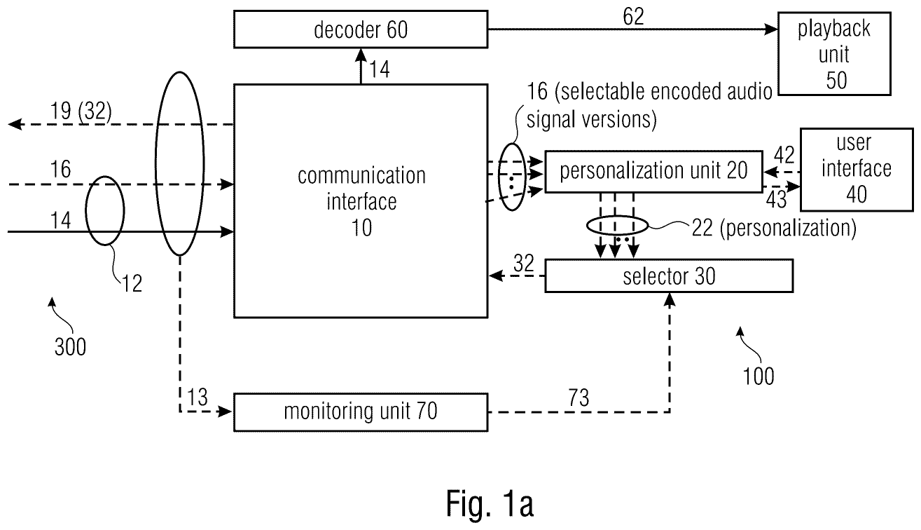

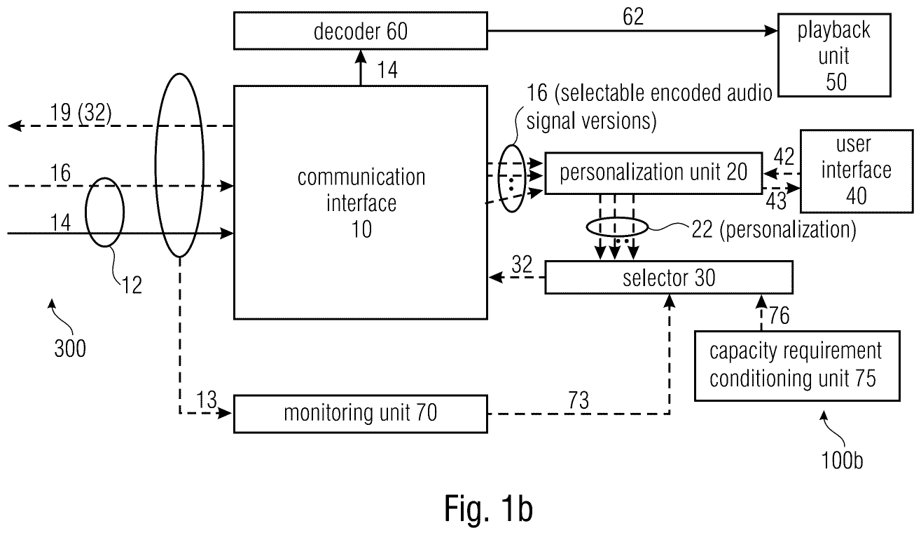

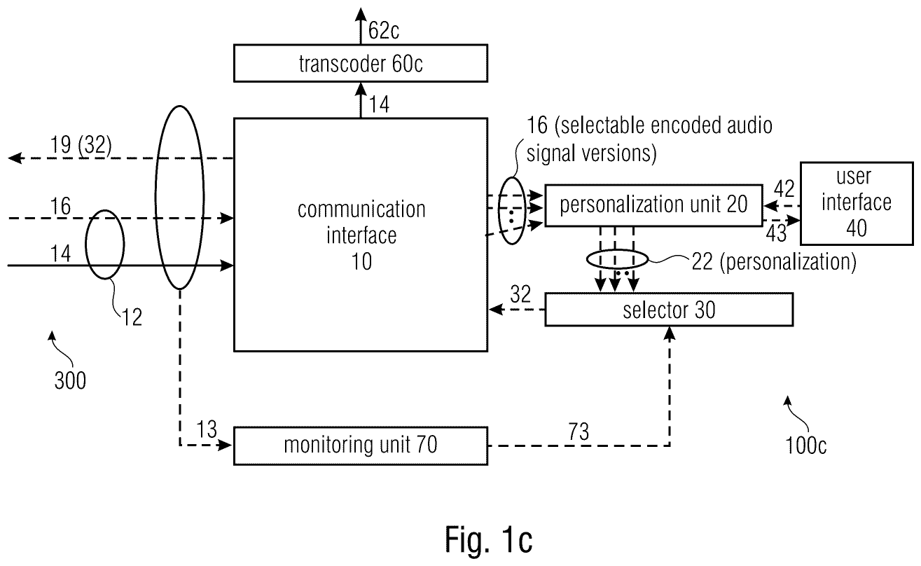

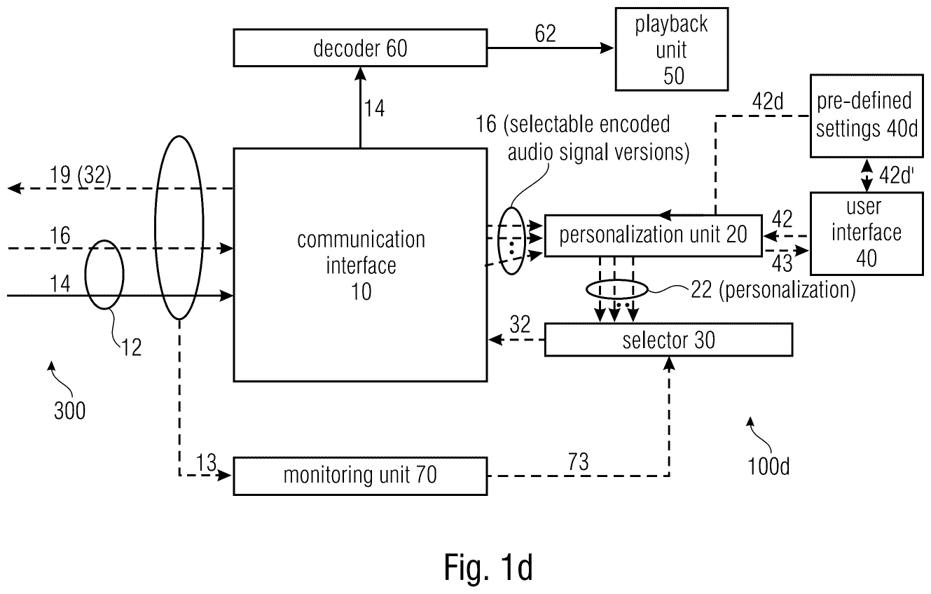

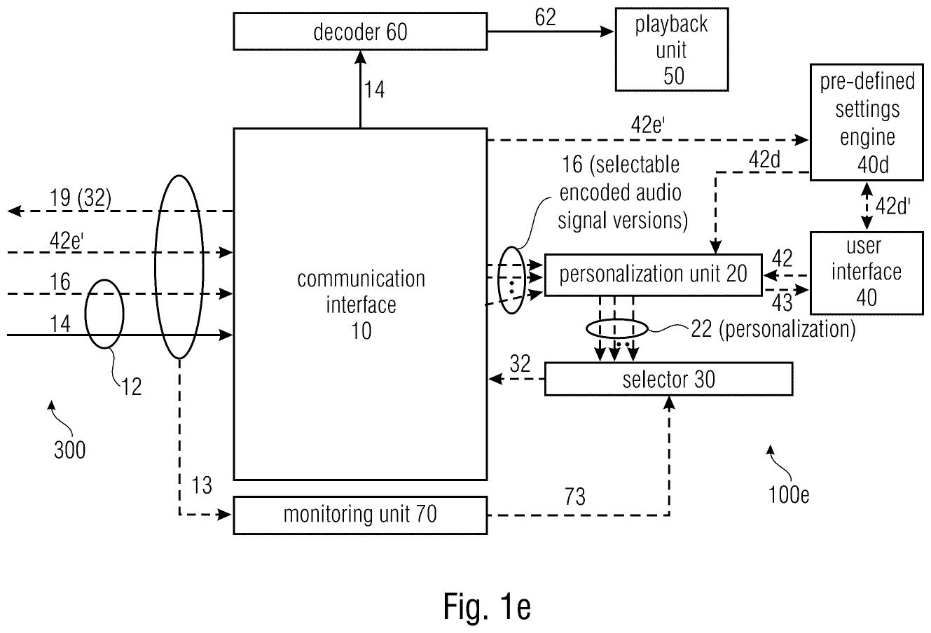

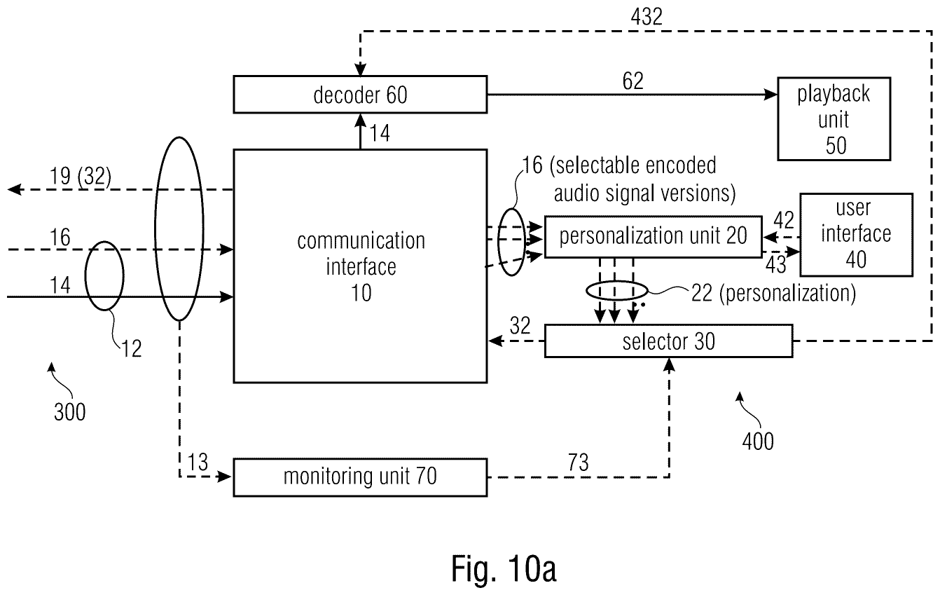

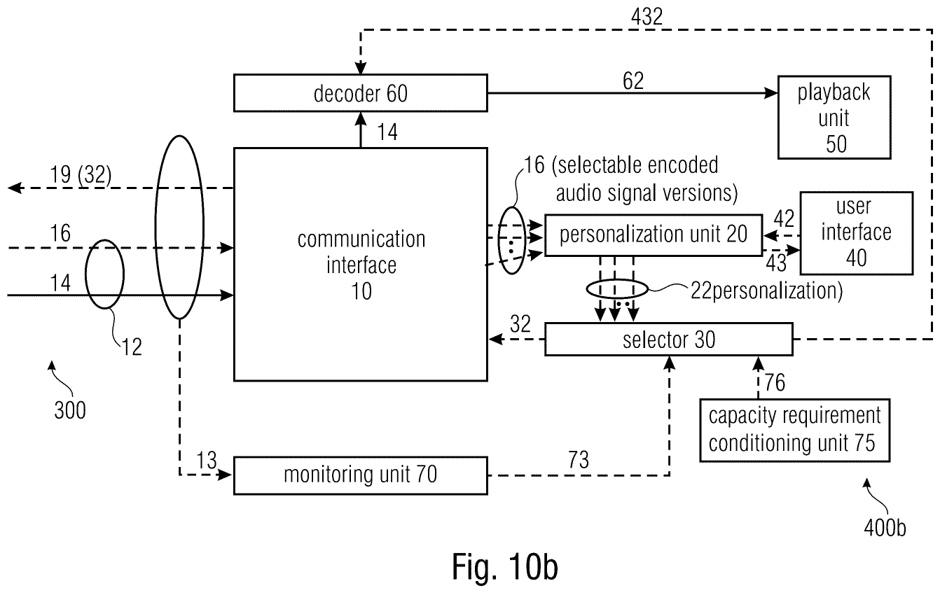

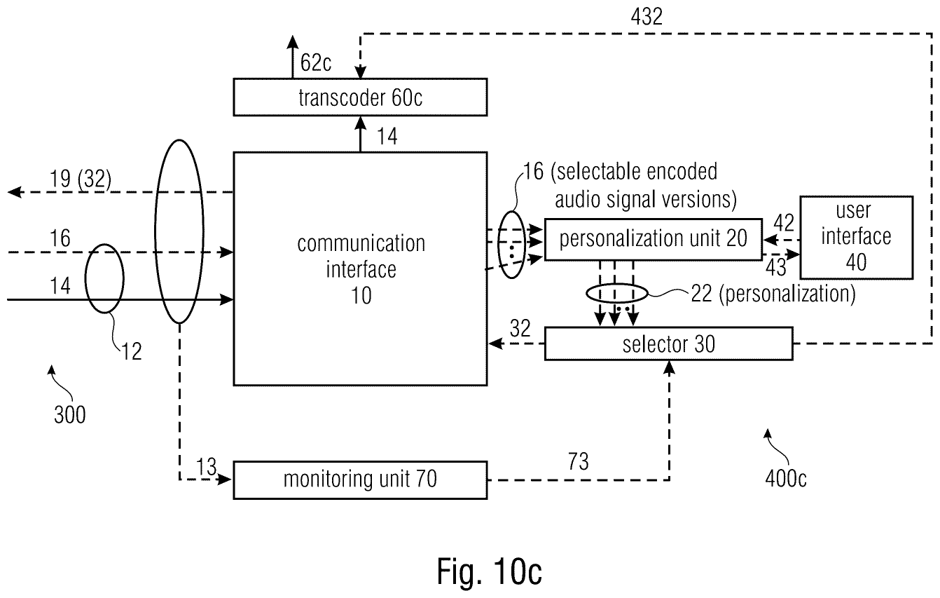

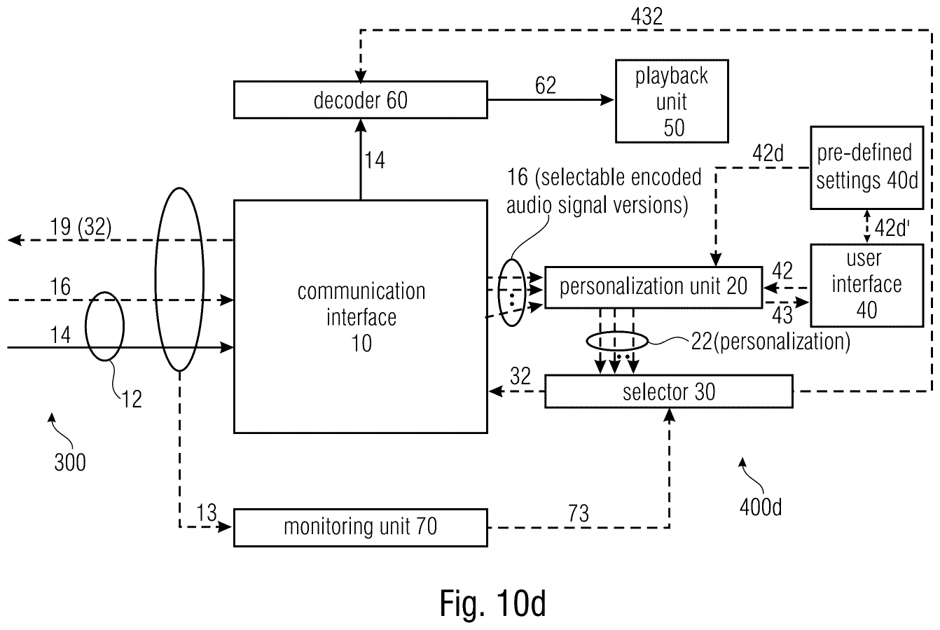

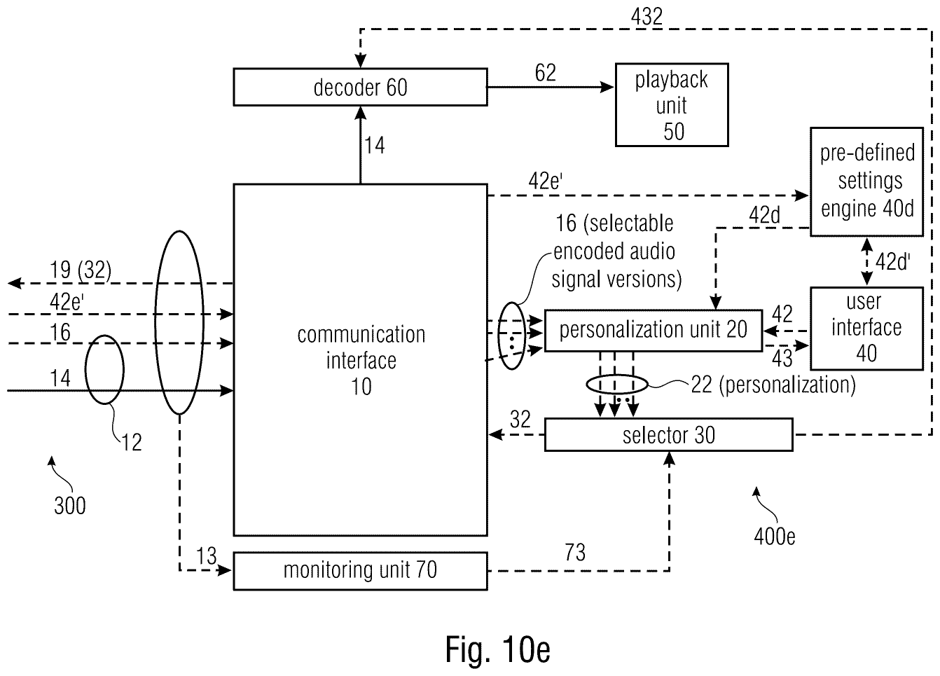

FIGS. 1a-1e and 10a-10e show examples of streaming client devices 100, 100b, 100c, 100d, 100e, 400, 400b, 400c, 400d, 400e. There is represented a streaming client device 100 (respectively 100b, 100c, 100d, 100e, 400, 400b, 400c, 400d, 400e), which may receive a bitstream 12, the bitstream 12 including an encoded audio signal 14 and side information 16. The encoded audio signal 14 may be audio information (e.g., sound) encoded in compressed form and which is to be decompressed (decoded) by the streaming client device 100 to be played back to a user. The streaming client device 100 (or 100b, 100c, 100d, 100e) may be in communication (e.g., through a communication network 300, such as the internet or a local network or a combination thereof, and which may be wireless, wired, or both) with a streaming sever device. Through the communication network 300 the streaming client device 100 (or 100b, 100c, 100d, 100e) may transmit and/or receive information (e.g., it may transmit requests 19 towards the streaming server device and/or receive the bitstream 12 from the streaming server device). The streaming client device 100 (or 100b, 100c, 100d, 100e, or 400-400e) may include a communication interface 10, which may permit the communication. For example, the communication interface 10 may send requests 19 to the streaming server device and may receive the bitstream 12.

The bitstream 12 may include the encoded audio signal 14, which may be encoded according to an encoded audio signal version (current encoded audio signal version). It will be shown that the encoded audio signal version may be selected among a plurality of selectable encoded audio signal versions (e.g. representations). The bitstream 12 (or at least the encoded audio signal 14) may be segmented (e.g. in self-decodable segments), and it is in general possible to change the encoded audio signal version during the bitstream's reception, e.g., after a request (19) updating the selected encoded signal version (see also below), so that the subsequent segment is transmitted by the streaming server device according to the updated selected encoded signal version. In general terms, the encoded audio signal 14 is segmented in a plurality of segments, and each segment (e.g. self-decodable segment) is interchangeable with a respective segment of an encoded audio signal of at least one different encoded audio signal version.

The bitstream 12 may include side information 16. The side information 16 may list the plurality of selectable encoded audio signal versions. For each selectable audio signal version listed in the side information, the bitstream 12 may also include further side information 16, including e.g. configuration information indicating at least one personalization option. The at least one personalization option may be, for example, an option on an audio attribute, which characterizes the particular selectable encoded audio signal version. For example, the encoded audio signal 14 may include one dialog language (e.g. English, French, Spanish, etc.), or another option (e.g. a different ratio between the resolution of different channels in the version, so that e.g. a first selectable version has a first ratio between the resolution of a first channel, or groups of channels, and the second channel, or second group of channels, and a second selectable version, alternative to the first selectable version, has a second ratio, different from the first ratio, between the resolution of the first channel, or groups of channels, and the second channel, or second group of channels). A different selectable version may be encoded using a different codec, for example. The at least one personalization option may be defined in terms of a preselection: there may be a complete set (combination) of multiple personalization options which, combined with each other, assigned to the particular selectable encoded audio signal version. The personalization may include, for example, the choice of the codec according to which the selected version is encoded. Examples of codecs are MPEG-H 3D Audio, Extended HE-AAC (USAC), AC-4, etc. Examples of personalization options may include at least one of gain level, position data, audio object selection (a group of audio objects/channels were only one at a time is active, for example the main dialogue of an movie) or muting and unmuting of specific audio object, mixing values for components of the encoded audio signal, information on selection and deselection of components of the encoded audio signal, information used to influence the rendering of components of the content. The configuration information may be received synchronously with the reception of the encoded audio signal 14. In alternative, the configuration information may be received before the reception of the encoded audio signal 14 (e.g. in a manifest). In some examples, a first portion of the configuration information may be received partially before the reception of the encoded audio signal 14 (e.g. in the manifest), and a second part of the configuration information may be sent synchronously with the reception of the encoded audio signal 14 (e.g., like an update).

The side information 16 of the bitstream 12 may also provide capacity information indicating capacity required, by the selectable encoded audio signal version, by an external resource (e.g., a particular bitrate). The side information 16 of the bitstream 12 may include capacity information which indicates the capacity required, by each selectable encoded audio signal version, by an external resource (e.g., a network resource, such as the bandwidth required to the network 300 transporting the transmission of the bitstream 12). Therefore, the capacity information may be often generally indicated as bitrate. Each selectable encoded audio signal version (according to each personalization) may therefore be associated with a particular bitrate (capacity required to the external resource, such as the network). Multiple selectable encoded audio signal versions may have the same bitrate (but with different audio options); further, multiple selectable encoded audio signal versions may have different bitrates (and have different audio options). Different selectable encoded audio signal versions may have the same bitrate, but be distinguished from each other for their selectable options. For example, a first selectable version could have a first number of channels greater than a second selectable version, but the second selectable version could have further options which are not provided by the first version: the capacity required by each version could be the same, and the selection would decide, based on the personalization, the selected version among the first and the second versions, e.g. based on an evaluation and/or pre-selections (e.g. made by the user) (see also below).

It will be noted that one single personalization may define multiple bitrates: the higher the bitrate, the higher may be the resolution (and/or the quality) of the audio information encoded in the encoded audio signal 14 (in particular if the same codec is used). In general terms, a user would prefer to have high quality encoded audio signals 14, even though the network capacity not always permits the provision, in real time, of an encoded audio signal version at a high bitrate. In some examples, the higher the resolution (and the bitrate), the higher the number of channels (or more in general the spatial resolution). For example, a 2-channel encoded signal version has in general a higher bitrate than a 1-channel encoded signal version (more in general, the higher the bitrate, the higher the number of channel, in some examples). In examples, the choice of the highest bitrate is limited by the choice of the codec: it is in principle not guaranteed that all the selectable versions have the same codec and, when a codec is chosen for bitstream 12, the subsequently selected versions will have the same codec of the previous one. In some examples it may be not allowed to switch from a version encoded according to a codec to a different version encoded according to a different codec.

In examples, for the listener (user), each personalization option (or set or combination of personalization options) represents an option that they can choose, or refrain from choosing, at their wish. In addition or alternative, the user does not necessarily explicitly request a particular personalization option or set or combination of options, but a pre-defined personalization is defined, e.g., automatically defined by options (which may have be selected by the user at an initialization procedure, or are options pre-defined in factory, etc.). It will be shown that the bitrate of a selectable version is not necessarily one of the personalization options: in some examples the bitrate may therefore not be part of the personalization controlled by the user, but can be defined automatically by bitrate adaptation. E.g., the bitrate could be chosen as based on the bandwidth, so as to have the highest bitrate possible according to the network's capacity, or it could be defined through a data plan. Or, a fast tune-in could be implemented, so as to start with a low bitrate and subsequently to switch to higher bitrate to avoid the introduction of a starting delay.

Therefore, the personalization permits to choose a preferred version for each potential state of the external resource (e.g. network), so that the selection of the version to be received is not only based on the capacity required by each selectable version, but also on other parameters defined by the personalization. This greatly enhances the personalization's possibilities for the user, because they can choose among a broader scope of possibilities.

The streaming client device 100 (or 100b, 100c, 100d, 100e, 400, 400b, 400c, 400d, 400e) may include a personalization unit 20. The personalization unit 20 may define a personalization 22 of the received bitstream 20. The personalization 22 may be instantiated by choosing, for each potential state on the external resource (e.g., network 300) among a plurality of potential states, a preferred encoded audio signal version among the plurality of selectable encoded audio signal versions. The personalization unit 20 may, therefore, decide that, for certain networks bandwidth(s), a particular encoded audio signal version will be preferred, while for other bandwidth(s), a different encoded audio signal version will be preferred. In some examples, the personalization unit 20 may generate a table associating different network's bandwidths (or more in general states of the external resource) with different selectable encoded audio signal versions (e.g. preferring, for each potential state, a particular selectable encoded audio signal version). (In other examples, it is possible to associate different network's bandwidths, or more in general states of the external resource, with different selectable encoded audio signal versions, even without a table.) Since each selectable encoded audio signal version is associated to at least one personalization option (e.g. a set, or combination, of personalization audio options), the personalization unit 20 will choose, in examples, the preferred encoded audio signal version among those listed in the side information 16 of the bitstream 12. The preferred encoded audio signal version for each network's bandwidth (or more in general for each state of the external resource) is also chosen, by the personalization unit 20, for each capacity information as provided in the side information 16 of the bitstream 12 and associated to each selectable encoded audio signal version 16. Also, the configuration information (indicating the at least one personalization option over a complete set, or combination, of multiple personalization options combined with each other) may be taken into consideration. The personalization unit 20 may be understood, in some examples, as operating (e.g., preferably) at the start of the reception of the bitstream 12: the side information 16 may be part of a manifest (which is a file that is normally transmitted, as side information 16, at the start of the bitstream's transmission) or may be notwithstanding be transmitted at the start of the bitstream's transmission, so that the personalization unit 20 may decide the preferred encoded audio signal version to be subsequently received. In examples, with or without the transmission of the manifest, the side information 16, indicating the configuration information and the capacity information, is transmitted in parallel, e g. synchronously, to the transmission of the encoded audio signal 14. The personalization unit 20 may define the codec (e.g. among MPEG-H 3D Audio, Extended HE-AAC, AC-4, etc.). When the list of selectable encoded audio signal versions is provided in the side information 16 (together with the configuration information and the capacity information associated to each selectable encoded audio signal version), the personalization unit 20 may operate at the start up, e.g. preparing a table associating potential states 73 on the external resource 13 (e.g., bandwidths of the communication network) with selectable encoded audio signal versions. In some examples the table (being part of the personalization 22) may be updated subsequently, e.g. through a new user's command (and, in the case in which there is no update, the table will be maintained during the whole transmission of the bitstream 12). In some examples, the personalization may require a first codec for a first potential state on the external resource (e.g., network 300), and a second codec for a second potential state of the external resource.

Therefore, for each potential state of the external resource, a preferred version is chosen among the selectable versions that match the potential state. The actually selected version will therefore be the one that, for a particular current state, is the preferred version among those that match the current state. Notably, the selection is not only based on the particular capacity required by each selectable version, but also on the options provided by the various selectable versions.

FIGS. 1a-1e and 10a-10e also show a user interface 40 (which may be inputted by and/or provide outputs to a user). The user interface 40 may provide at least one user interface personalization input 42 which may condition the personalization unit 20 to define the personalization 22. The user interface 40 may (in some examples) also obtain, from the personalization unit 20 or the communication interface 10, personalization information 43 on the selectable encoded audio signal versions listed in the side information 16. The personalization information 43 may indicate (e.g. by visualizing on a display and/or by suggesting though an audio message) at least one personalization option, e.g. to guide the user to provide personalization input 42 to condition the personalization unit 20 in defining the personalization 22. For example, an output 43 in the display (as part of the user interface 40, or being controlled thereby) could request to the user to select a particular personalization information 43 to be provided to the personalization unit 20, so as to condition the choice of the preferred encoded audio signal version (this could be performed through an audio message). In some cases, it is not (or not only) the listener (user) that decides which personalization audio options are to be chosen: for example, the personalization 22 may be in or include pre-defined settings 42d (e.g. in the example of the example of FIG. 1d and FIG. 10d), or may be at least partially defined by a remote provider (e.g., in FIGS. 1e and 10e, where the pre-defined settings 42e′ are provided to the personalization unit 20 as personalization input 42d). In some examples, the user may be even (at least in theory) not aware on the personalization audio options that are selected: for example, the user in general doesn't care of the codec used, but they simply intend to have a particular audio service. Therefore, the user can co-participate to the personalization 22, but in some cases the personalization 22 may be semi-automated (e.g., through the use of the user interface 40, see below). Therefore, in some cases, the personalization inputs 42 and 42d may cooperate to define a personalization 22. When the personalization 22 is defined, then the selection of the version may be a matter of matching the capacity required by the preferred version in the personalization and the state of the external resource (e.g. the capacity that the external resource can provide).

In general terms, the personalization unit 20 may adopt a particular personalization criterion, which may be pre-defined (e.g. default criterion) or may be defined at least partially by the user (e.g., through the user interface 40). The personalization criterion may, therefore, be provided to the personalization unit 20 as part of the personalization information 43 provided by the user, or may at least be partially defined by the user or by the interaction with the user. The personalization criterion may establish at least one evaluation condition on the at least personalization option. A value (option value) of at least one personalization option may be evaluated (e.g. by the personalization unit 20) version-by-version among the plurality of selectable encoded audio signal versions, so as to sort different selectable encoded audio signal versions according to the values of the personalization option (e.g., forming a ranking based on the evaluation condition, so that the more the at least one evaluation condition is respected by a selectable encoded audio signal version, the higher the ranking of that selectable encoded audio signal version). If a personalization option, for example, has a binary value (i.e. either “true” or be “false”, or equivalently “0” or “1”), then at least one evaluation condition may be evaluated on whether the personalization option has a pre-defined value or not. The personalization criterion may become “choose the selectable encoded audio signal version having the personalization option equal to true” (or, vice versa, e.g. “equal to false”). Accordingly, the personalization unit 20 will define the personalization 22 by preferentially choosing, as preferred encoded audio signal version, the selectable encoded audio signal version having the binary personalization option being “true” (or vice versa). The meaning of “preferentially choosing” may be understood as increasing the ranking of those selectable encoded audio signal versions which fulfil the evaluation condition (and/or which fulfill the personalization criterion), so that those selectable encoded audio signal versions increment their positions in the ordering; and, in parallel, decreasing the ranking of those selectable encoded audio signal versions which do not fulfil the evaluation condition. There may be non-binary personalization options. For example, the personalization option may be defined in a range of values (e.g. one single range of values, or a plurality of ranges of values), and the personalization criterion could establish an evaluation condition regarding the value (e.g., gain, or one or more positional coordinates of an audio object in a 3D sound environment): the evaluation condition may be evaluated through a comparison of the option value with a particular threshold (evaluation threshold). The threshold may be chosen, for example, by a user, e.g., through the help of the user interface 40; or may be a default threshold. Another personalization criterion (and/or evaluation condition) may be based on a “nearest value” condition: if it is required the personalization option to have a required value (e.g., value B, where B is a rational, number, e.g. B=5.0), e.g. for the gain or for an audio object position, the personalization may define, as preferred encoded audio signal version, the encoded audio signal version whose option value is closest to the required value (e.g., if there are three selectable encoded audio signal versions 1.0, 2.0, 3.0, where B=4.8 for version 1, B=4.9 for version 2, and B=5.2 for version 3, the preferred version will be version 2, having the lowest distance from the required value B=5). In general terms, however, the personalization unit 20 may choose the preferred encoded audio signal version(s) by evaluating at least one evaluation condition e.g. established by the personalization criterion. The at least one evaluation condition may be a condition on at least one of the personalization options listed in the configuration information of the side information 16 (e.g. in the configuration information). The personalization unit 20, e.g. following the personalization criterion and/or the at least one personalization condition, may define, for each capacity (e.g., bitrate) allowed by the external resource (network) at least one ordering (ranking) among the selectable encoded audio signal versions, so that the highest-ranking version in the ordering is the preferred encoded audio signal version for the particular capacity (bitrate). The selection may then select, for a particular current state of the external resource (e.g. as measured by a monitoring unit 70, see also below), the highest-ranking version (preferred version) among those whose required capacity matches the current state. In general, the personalization criterion (or more in general the at least one evaluation condition) may evolve in time: for example, the modification of the personalization criterion (or more in general the at least one evaluation condition) may be conditioned by the personalization input 42 and/or 42d (it will be shown that it may also be conditioned by a capacity requirement conditioning unit 75, like in FIGS. 1b and 10b). For example, if the personalization option is a preselection, and sets the dialogue language, such as English, French, Spanish, of the audio signal, the user could request, through the user interface 40 and provided by the personalization input 42 (or 42d), the modification of the preselection (e.g., switching from English to German): this will involve the modification of the personalization 22 by the personalization unit 20, which, for each capacity (bitrate) will associate a different preferred encoded audio signal version. Therefore, the evaluation condition may be understood as providing at least one ordering to sort the selectable encoded audio signal versions according to a ranking, so that the personalization unit 20 chooses the highest-ordered selectable encoded audio signal version as the preferred encoded audio signal version. After that, the selection will select the highest-ranking version (preferred version) among those whose required capacity matches the current state.

The at least one evaluation condition may include, in some examples:
1. at least a first evaluation on a first evaluation condition on at least one first personalization option, or a first set or combination of personalization options, and
2. (optionally) at least one a second evaluation on at least one second personalization option, or a second set or combination of personalization options. (Optionally further recessive conditions may be evaluated)

(This is not always the case. There are use-cases in which all personalization options are set within a preselection and therefore, no second evaluation step or second personalization option exists.)

Accordingly, there may be defined at least one first ordering to sort the selectable encoded audio signal versions according to the first evaluation, and at least one second ordering to sort the selectable encoded audio signal versions according to the second evaluation, so as to choose (e.g. in the personalization) the preferred encoded audio signal version based on at least one of the first ordering and the second ordering. Notably, when receiving the encoded signal version, there will be no necessity of always evaluating all the conditions: the selected version will be (e.g. for each segment) that preferred already defined in the personalization 22 (it will only be necessary to select the version, among all the preferred versions, which matches the state of the external resource). In some examples, the first evaluation condition may be dominant and/or be on a so-called preselection (e.g. preselecting a dialog language), and the second evaluation condition may be recessive (secondary), and the second ordering may therefore permit to define secondary options that are less important that the dominant ones. There may be multiple levels of hierarchy, and a higher-ranking evaluation condition may therefore be dominant over a lower-ranking evaluation condition. In non-hierarchical examples, there may be defined an assignment of a first score from the first evaluation, and a second score from the second evaluation, so as to define a final ordering by using both the first score and the second score. Notably, in some examples, while receiving the selected encoded signal version, all these evaluations are not made anymore, since it is simply selected the preferred version whose capacity matches the state of the network.

In some examples, a first codec may be preferred for a first state (e.g., higher bandwidth), while a second code (e.g., a less capacity-demanding code) may be preferred for a second state (e.g., higher bandwidth).

At least one personalization option may include at least one of gain level, position data, audio object selection (a group of audio objects/channels were only one at a time is active, for example the main dialogue of a movie) or muting and unmuting of specific audio object, etc. a set (or combination) of personalization audio option options may include a plurality of the options.

For example, different personalization options may involve different ratios between the resolution of different channels in the version, so that e.g. a first selectable version has a first ratio between the resolution of a first channel, or groups of channels, and the second channel, or second group of channels; and a second selectable version has a second ratio, different from the first ratio, between the resolution of the first channel, or groups of channels, and the second channel, or second group of channels: the evaluation condition may be a condition on the ratio, so that the first ratio is preferred (and subsequently selected, in case of matching), or the second ratio is preferred (and subsequently selected, in case of matching) in accordance with the personalization options.

FIGS. 1a-1e and 10a-10e also show a monitoring unit 70 (which may be also optional or external). The monitoring unit 70 may monitor the state 73 of an external resource 13 (e.g., the network's bandwidth 13 at the disposal of the transmission of the bitstream 12). The monitored state 70 may therefore be used for actually selecting the encoded audio signal version to be requested to the streaming server device. The monitoring unit 70 may obtain the current state 73 of the external resource 13 (e.g. bandwidth of the network 300) by measuring delay information regarding the arrival of at least one data packet of the bitstream 12 in respect to at least one time stamp encoded in a field of the respective data packet. Hence, a measurement 73 of the external state 13 is in such a way that the higher the delay, the less capacity (e.g. less bandwidth) has the network 300. In alternative, the current state (73) of the external resource (13) may be obtained from a monitoring unit which is implemented in an operating system which is operative in the streaming client device 100 (or any of 100b-100e). Other monitoring techniques may be carried out. Instead of the monitoring unit 70, measurement or other information 73 on the monitoring state may be provided by a different entity (e.g., a provider and/or the streaming server device).

FIGS. 1a-1e and 10a-10e show a selector 30. The selector 30 may perform the operation of selecting (32) the encoded audio signal version to be requested to the streaming server device. The selector 30 may operate on the fly and, based on the monitored state 73 of the external state (e.g., network bandwidth, and also based on the personalization 22 as defined by the personalization unit 20), may select exactly the encoded audio signal version (which may be unique) to be requested to the streaming server device. Often, the higher the bandwidth 13 at disposal of the transmission of the bitstream 12, the higher the bitrate of the selected encoded audio signal version 32; the lower the bandwidth 13 (73), the lower the bitrate of the selected encoded audio signal version 32. Analogously, the higher the bitrate, the higher the bandwidth 13 (73) at the disposal of the transmission of the bitstream 12, the higher the probability that the selected encoded audio signal version 32 will encounter the user's preference (since, by virtue of the fact that multiple selectable encoded audio signal versions are at the disposal of the user, it would be easier if the user's request are satisfied and the quality is high). (It will also be shown, in particular with reference to FIGS. 10a-10e, that, the higher the bandwidth, the greater the number of alternative personalization options that can be present in one selectable encoded audio signal version). The communication interface 10 will send a request 19 requesting the provision of the encoded audio signal 14 according to the selected audio signal version 32 as selected by the selector 30. Hence, at least from the subsequent bitstream's segment, the bitstream 12 will be provided according to the selected audio signal version 32. (It will also be shown, in particular with reference to FIGS. 10a-10e, that, it won't always be the case that the request 19 is to be transmitted, because some alternative personalization options may be latently already present in the currently received audio signal version 32, and it is only necessary to activate them).

Some filtering may be opportune in examples, to avoid that different selections are continuously updated. The monitored state 73 may therefore not be an instantaneous state, but may take into consideration the evolution of the bandwidth in the immediately preceding minutes (e.g., in a temporal range of at maximum the last 10 minutes or 20 minutes). In addition or alternative, the state 73 may be obtained (at least partially) as a prediction of the bandwidth, e.g. predicted through historical and/or statistical data, e.g. after having taken into consideration the current instantaneous network state and/or the immediately preceding states).

The encoded audio signal 14 as received in the bitstream 12 is therefore provided to a decoder 60 by the communication interface 10. The decoder 60 may provide, (e.g., through an electric or wireless connection 62) the decoded version of the encoded audio signal 14 as received. The playback unit 50 will provide the sound to the user (the playback unit 50 may be part of, or external to, the device 100). The decoder 60 may be substituted by a transcoder 60c (e.g., in FIGS. 1c and 10c). The decoder 60 may decompress the encoded audio signal 14 received in the bitstream 12, and/or perform the mixing, upmixing, spatial mixing, etc. e.g. taking into consideration parameters encoded in the bitstream 12. The decoder 60 (or transcoder 60c) may be controlled by the user interface 40 or by other settings or a setting engine (e.g. 40d in FIGS. 1d and 10d) or by a playback unit 50, despite not being shown in the figures for simplicity. (It will also be shown, in particular with reference to FIGS. 10a-10e, that some control can be exerted by the so-called second selection 432, which may activate, deactivate, and/or choose alterative personalization options which may be latently present in the encoded audio signal 14 currently received in the bitstream 12, but currently not rendered).

FIGS. 1b and 10b show examples of streaming client devices 100b, 400b which are completely analogous to the streaming client device 100 of FIGS. 1a and 400 of FIG. 10a, apart from the fact that also a capacity requirement conditioning unit 75 is provided, which may output a capacity requirement conditioning information 76 to the selector 30, indicating an amount of capacity (e.g., bitrate) required at a particular time instant. The capacity requirement conditioning unit (pattern selection unit) 75 may provide a predefined selection pattern as capacity requirement conditioning information 76. The capacity requirement conditioning information 76 may require an instantaneous bitrate to be used by the selector 30. The required instantaneous bitrate may follow a predefined selection pattern which may require a particular bitrate independently of the monitored bandwidth 73. In case the bandwidth required by the capacity requirement conditioning information 76 is above the capacity at disposal of the transmission, the selector 30 will ignore the capacity requirement conditioning information 76, in examples. In case the bandwidth required by the capacity requirement conditioning unit 75 is below the network's bandwidth, the selector 30 will notwithstanding select the bitrate required in the required capacity information requirement indicated in the capacity requirement conditioning information 76, in examples. The reason for requiring a bitrate less than the monitored bandwidth may lie in that it may be intended to follow a predefined data plan (e.g. so bandwidth is not limited but it might be preferable to save bandwidth), the data plan being stored in the capacity requirement conditioning unit 75. In addition or alternative, a selection pattern (also stored in the capacity requirement conditioning unit 75) may implement a fast tune-in function, so that at the startup a low bitrate is selected, and subsequently (e.g. after a pre-defined amount of time) the selector 30 selects a higher bitrate version, e.g. with the effect of avoiding a starting delay. The capacity requirement conditioning information 76 may cause different selections at the same bandwidth even if the network 300 has enough capacity to operate at a higher bandwidth. Even if not shown, the capacity requirement conditioning unit 75 may be connected to the personalization unit instead to the selector 30, or to both of them, so that the capacity requirement conditioning information 76 conditions the personalization 22, directly. The capacity requirement conditioning unit 75 may perform the filtering, as discussed above.

As explained above, FIGS. 1a, 1b, 10a and 10b show examples of apparatus 100, 100b, 400, 400b of the decoder 60 providing a decoded (e.g. decompressed) version 62 of the bitstream 12 (and in particular the audio signal 14) is towards a playback unit 50 (e.g. renderer). Instead, FIGS. 1c and 10c show variants of a streaming client device 100c, 400c in which the decoder 60 is substituted by a transcoder 60c (or by a unit that performs both the function of the decoder 60 and the transcoder 60c). The transcoder 60c may transcode (e.g. decode and, subsequently, re-encode) the encoded audio signal 14 from a first encoded version (the one transmitted from the streaming server device) to a second encoded version 62c. The second encoded version 62c may be stored in a storage unit (e.g., flash memory, hard disk, floppy disk, digital versatile disk, DVD, BluRay, etc.) or transmitted to another device (e.g. another decoder), either through the same communication network 300, or through another transmission resource (e.g., another network, or a vicinity transmission resource, Bluetooth, WiFi, ZigBee, Ethernet etc.), which may be wired or wireless. The streaming client device 100c may also include the pattern selection unit 75 of FIG. 1b and therefore operate (at least in some examples) as the streaming client device 100b, with the only peculiarity of transcoding instead of simply decoding.

The personalization unit 20 is not necessarily to be controlled (42) uniquely by a user interface 40. FIGS. 1d and 10d show variants 100d, 400d in which pre-defined settings 40d (e.g., stored in a storage unit) may provide personalization input 42d in addition or in substitution of the user's personalization input 42. Personalization input 42d may be controlled by the user (e.g., through the user interface 40) in different times (e.g., even days before the transmission of the bitstream 12), and may be valid for a plurality of bitstream transmissions. Information on the personalization input 42d may also be provided to the user (this is why the arrow 42d′ is through the bidirectional). (The pre-defined settings 40d may include video on demand, VoD, preference). In addition or alternative, as shown in FIGS. 1e and 10e some or all the personalization information 42 may include or be based on a pre-defined setting 42d, processed by a pre-defined setting engine 40d, obtained from a service provider setting defined through a pre-defined setting information 42e′. In FIGS. 1e and 10e pre-defined settings 42d (which may be or include or be included in a video on demand, VoD, preference) is not to be considered as part of the bitstream 12, but may be understood as setting defined before the request of the transmission of the bitstream 12. For example, the pre-defined setting information 42e′ may be known by the service provider (e.g., the stream server device or another system controlling or including the stream server device) at the subscription of a provisioning service (which encompasses the transmission of the bitstream 12). The pre-defined setting information 42e′ (and/or the pre-defined setting 42d) may notwithstanding be conditioned by user's input (e.g., decided in advance, e.g. at the subscription of the provisioning service), e.g. through the connection 42d′ (the request from the communication device 10 towards the streaming server device is here not shown).

In the examples of FIGS. 1a-1e and 10a-10e, the user's personalization input 42 and/or the pre-defined setting 42d may define at least one of the evaluation conditions and/or the personalization criterion. In some examples based on of FIGS. 1a-1e and 10a-10e, the user interface 40 may output, towards the user (listener), personalization information on the selectable encoded audio signal versions as obtained in the side information 16 (the personalization information indicating the at least one personalization option or at least one set or combination of personalization options), so as to guide the user to define the personalization criterion and/or at least one evaluation condition.

In general terms, it is possible to change (e.g., through the user interface 40) the preferred audio signal version (22) based e.g. on the at least one personalization input (42): there is therefore updated the request (19) of the selected audio signal version (32) also during the reception of the bitstream (12). Hence, subsequently there is obtained the encoded audio signal (14) according to the updated selected audio signal version (32). Therefore, the personalization unit 20 and the selector 30 may advantageously operate on the fly.

The difference between the examples of FIGS. 10a-10e and those of FIGS. 1a-1e is now explained. As can be seen, the examples of FIGS. 10a-10e permit a second selection 432 (which not shown in FIGS. 1a-1e) among the personalization options in the current encoded audio signal version 14.

Some personalization options of the current encoded audio signal version 14 may be (e.g. locally), for example, selectably deactivated and activated, e.g. through the personalization input 42 (or 42d), e.g. set by the user. When a personalization option is deactivated (e.g. through the second selection 432), a personalization option may therefore be latently present, but not actuated (e.g. not decoded and/or not transcoded, or in any case not rendered). This may be the example of some channels, which may be selectably rendered or not rendered e.g. according to the personalization input 42 set by the user. There may be some codecs which permit more second selection than other codecs and it is possible to define the most preferable codec for each particular potential state (e.g. bandwidth) of the external resource (e.g. network). Following the configuration information associated with each selectable low-capacity version (and, in some cases, based on the personalization criterion and/or the evaluation condition), the personalization unit 20 may define (e.g. based on user's input 42 or preselection 42d) the most suited low-capacity version which correspond to the options chosen for the high-capacity option. Other personalization options may be selectively activated and deactivated despite being received by the streaming client device 400-400e.

There is the possibility of having some personalization options which are alternative to each other (e.g., one being activated at the expenses of the other(s)). In examples, the alternative personalization option(s) may be both transmitted, in parallel, in the same encoded audio signal version 14, even though only one is activated (and rendered), while the other ones are simultaneously deactivated (and not rendered), e.g. under a choice indicated (or at least conditioned) by the personalization input 42 (e.g., by the user) or 42d. The deactivated personalization option(s) may therefore be latently present in the current encoded audio signal version 14, but their rendering is not actuated (it may be that it is even not decoded or transcoded, in some examples). For example, alternative personalization options may regard the dialog language: the same encoded audio signal version 14 may include both English dialog language and German dialog language, but only one of them is to be rendered. Therefore, the streaming client device 100-100e and/or the user may perform a second selection 432 choosing one dialog language by activating English and simultaneously deactivating German, or vice versa. In general terms, a selectable encoded audio signal version having deactivatable and/or alternative personalization option(s) requires a greater capacity (greater bandwidth), since more information is transmitted by the streaming server device than what is actually played back (therefore meaning that the capacity required by the encoded audio signal is larger). However, by virtue of the performing of the second selection 432, the activation/deactivation and/or the choice between the alternative personalization options is actuated, rather than requesting (through request 19) a new selectable encoded audio signal version to the streaming server device. Notably, in the side information 16 there may be indication of whether a personalization option(s) is, or is not, deactivatable, and/or whether two or more personalization options are alternative with each other. Therefore, the personalization unit 20 may define the most convenient personalization 22 in terms of bitrate, quality and user's request, and the selector 30 may select the encoded audio signal version by keeping into account it. For example, there are the following cases A and B:
A) in case of current status 73 of the network 300 permitting a high capacity (e.g. high bandwidth), an encoded audio signal version with many alternative options may be selected; and
B) in case of current status 73 of the network 300 only permitting a low capacity (e.g. low bandwidth), an encoded audio signal version with less alternative options may be selected (in some cases, one single personalization option may be chosen, which is the one defined by the personalization unit 22).

Notably, in some examples in cases A) and B) there are preferred (and therefore selected) different codecs. In other examples, in cases A) and B) there are preferred (and therefore selected) the same codecs.

In both cases, however, a same personalization option may be rendered to the user. However:
if the user changes personalization input 42 in the case of network 300 permitting a high capacity (case A), the actuation of the user's command will be performed through the second selection 432, and the new personalization option will be rendered immediately; and
if the user changes personalization input 42 in the case of network 300 permitting a low capacity (case B), this could be performed through the selection 32, and a new option would be requested (through request 19) to the streaming server device.

Therefore, if the network's capacity so permits (case A), the selector 30 may select that encoded audio signal version which requires a higher capacity than strictly necessary, but subsequent personalization inputs 42 or 42d are prepared for subsequent commands.

It is possible to establish a personalization criterion according to which a first alternative personalization option fulfils a dominant evaluation condition, and a second alternative option (alternative to the first alternative option) fulfils a recessive evaluation condition (multi-level, hierarchical conditions may be defined, e.g. including a tertiary condition, and so on). In this way, it is normally preferred to have an encoded audio signal version having both the first and second alternative options (e.g. when the bandwidth is high), but secondarily an encoded audio signal version having only the first alternative personalization option may be requested (e.g., when the bandwidth is subsequently reduced). For example, the dominant condition may require a first alterative option like a determined dialog language (e.g. English), and a secondary condition may require an alternative option like another dialog language (e.g., German), so as to ensure that, compatibly with the capacity (13, 73) of the network 300, both alternative options are received in parallel, despite one not being rendered, and, when the capacity of the network decreases (e.g. case B), at least the dominant option is received.

With the present examples, the number of selectable versions at disposal of being received can be increased: for each potential state of the external resource (e.g. network), there may be much more options at disposal of the user, and the user may choose (through the personalization 22), the preferred version which they will enjoy. The content provider is not restricted to simply change the resolution for different states of the external resource, but can also provide different options for each state of the of the external resource.

In some examples, the configuration information indicating the personalization options at disposal of being transmitted may change in time, e.g. together with the particular content being transmitted. Hence, there is the possibility of indicating, in real time (e.g. synchronously with the transmission of the encoded audio signal), which selectable version is at disposal of the user, and the personalization 22 may be updated in real time. At any update of the personalization 22, the preferred version may change (or not change), and subsequently the selected version may also change (or not change) according to the update of the personalization 22. In some examples, when the higher (and/or lower) capacity-requiring version is being received, it is possible that the configuration information is provided regarding the possible lower (and/or higher) capacity-requiring versions.

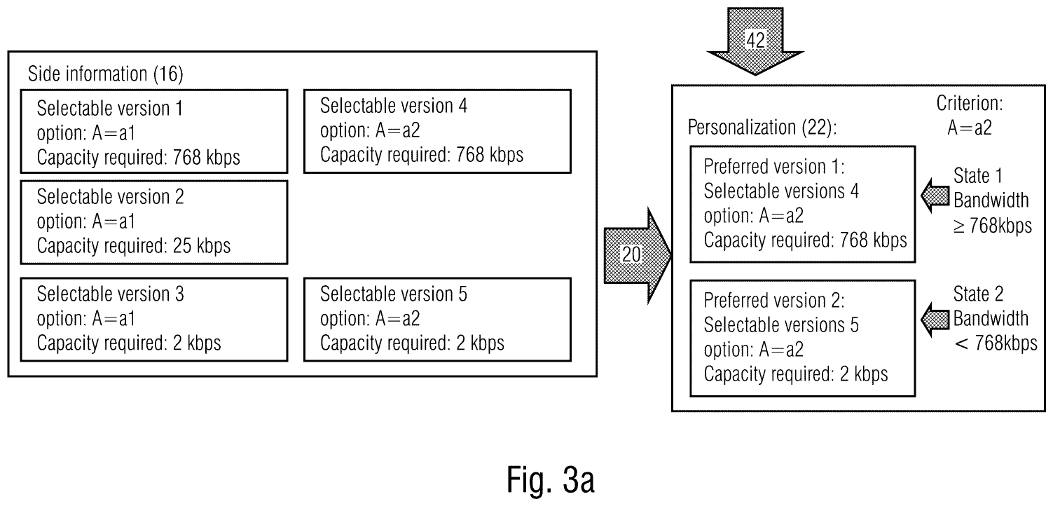

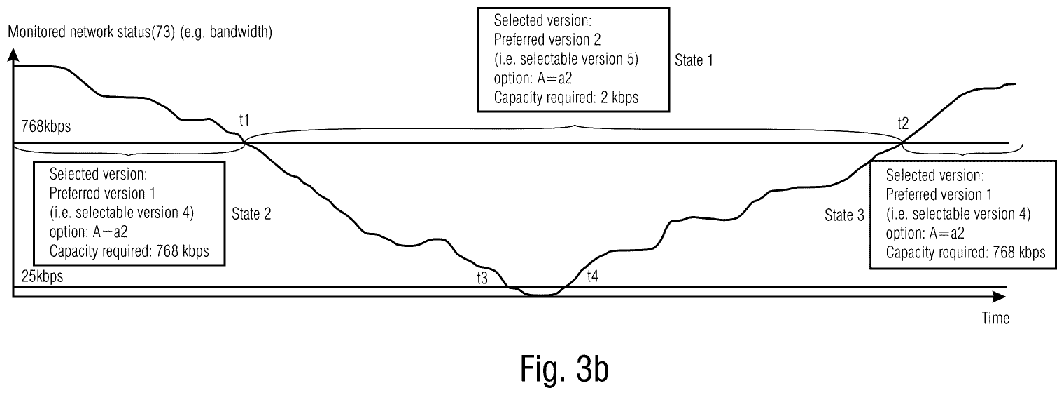

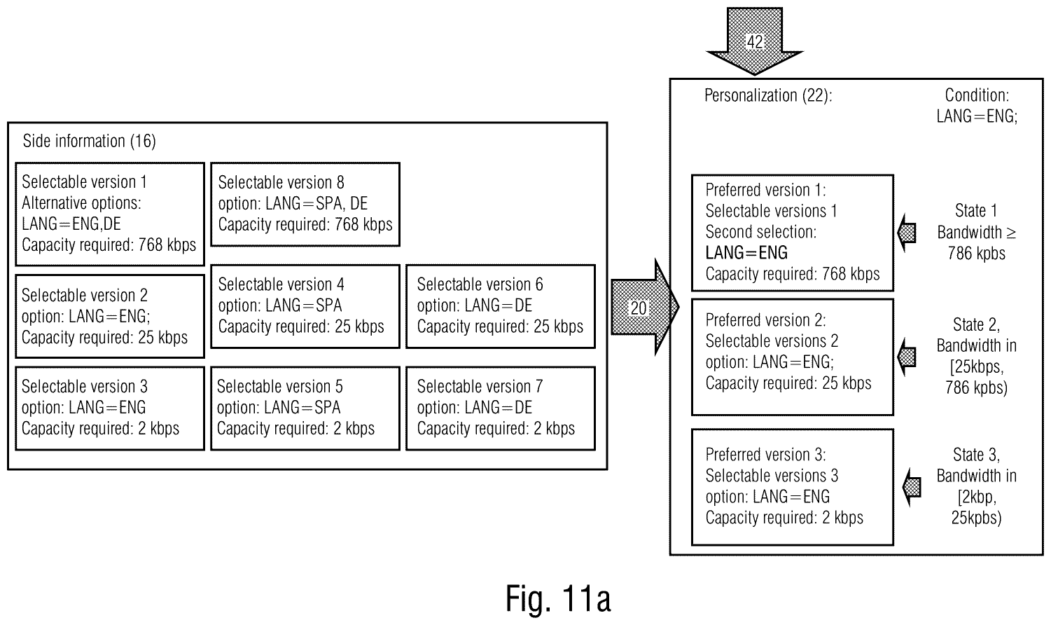

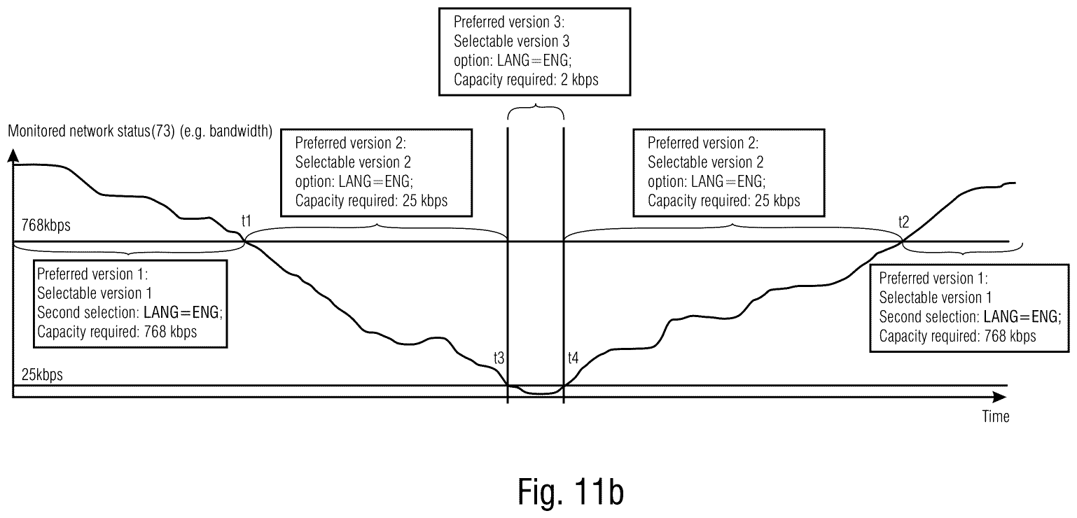

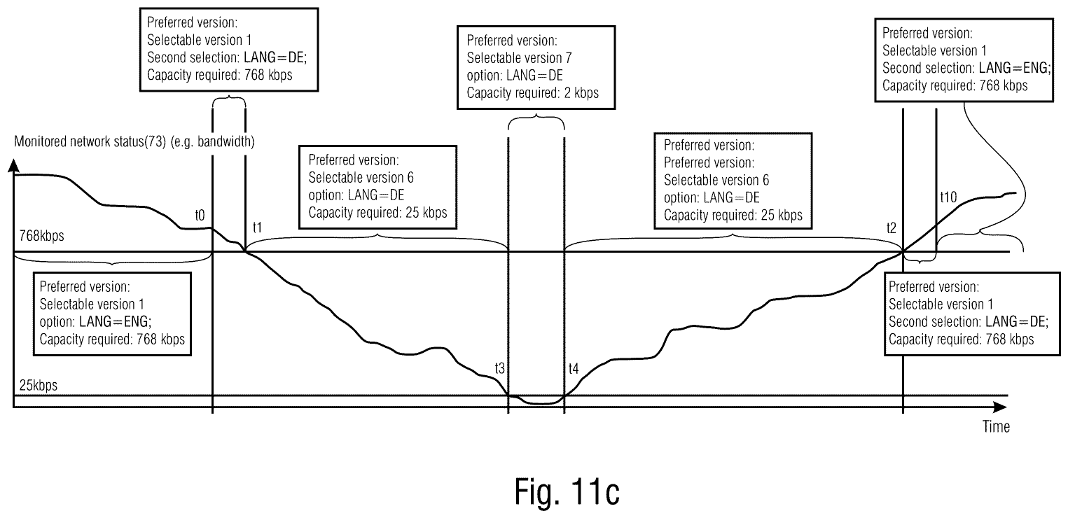

Examples regarding the functioning of the devices of FIGS. 1a-1e are shown in FIGS. 3a-7. Examples regarding the functioning of the devices of FIGS. 10a-10e are shown in FIGS. 11a-13b. In the examples, reference is often made to bandwidths with some given numbers for clarity (e.g. 768 kbps, 25 kbps, 2 kbps, etc.), which may be changed according to examples; also the number of states may be changed (e.g., two potential states or more). In some examples, different capacity requiring versions may be according to different codecs (but in other examples they may be according to the same codec).

An example of operation is provided by FIGS. 3a and 3b. FIG. 3a shows an example of side information 16 as part of the bitstream 12. There happen to be five selectable versions 1, 2, 3, 4 and 5 which the streaming server device can offer to the streaming client device. The selectable version 1 has the option A=a1 and requires a capacity of 768 kbps; the selectable version 2 has the option A=a1 and requires a capacity of 25 kbps; the selectable version 3 has the option A=a1 and requires a capacity of 2 kbps; the selectable version 4 has the option A=a2 and requires a capacity of 768 kbps; and the selectable version 5 has the option A=a2 and requires a capacity of 2 kbps. For some reasons (perhaps due to the authoring or for any other reasons), at the capacity of 25 kbps there is no selectable version providing the option A=a2. All this information is provided in the side information 16. The personalization unit 20 may therefore define a personalization 22 (which is also based on a personalization input 42 as provided by the user through the user interface 40) in which there are:
1. A preferred version 1 (which is the selectable version 4) which requires the capacity of 768 kbps.
2. The preferred version 2 (which is the selectable version 5) which require a capacity of 2 kbps.

Here, the personalization criterion (evaluation condition) has been that the option A is to be equal to a2 (e.g. because the personalization input 42 or/and 42d so requires). Therefore, two states of the network are considered:
1. A state 1 for a bandwidth equal or larger than 768 kbps.
2. A state 2 for a bandwidth smaller than 768 kbps.

Therefore, the personalization 22 in this case only chooses the selectable version 4 for the capacity of at least 768 kbps, and the selectable version 5 for the capacity of less than 768 kbps (but above 2 kbps). There is not provided a personalization for a selectable version at 25 kbps, since the only selectable version at 25 kbps is version 2, but version 2 does not fulfill the personalization criterion (evaluation condition) of having the option A=a2. Accordingly, if the bandwidth at disposal of the transmission is 25 kbps or less, the user will enjoy the sound at the preferred version 2 (selectable version 5), which is at 2 kbps. Even though the user will enjoy a sound at a lower bitrate, their personalization will not be lost. Further, as soon as the capacity of the communication network (or more in general of the external resource) is increased, the user will return to enjoying the sound provided by the preferred version 1 (selectable version 4).

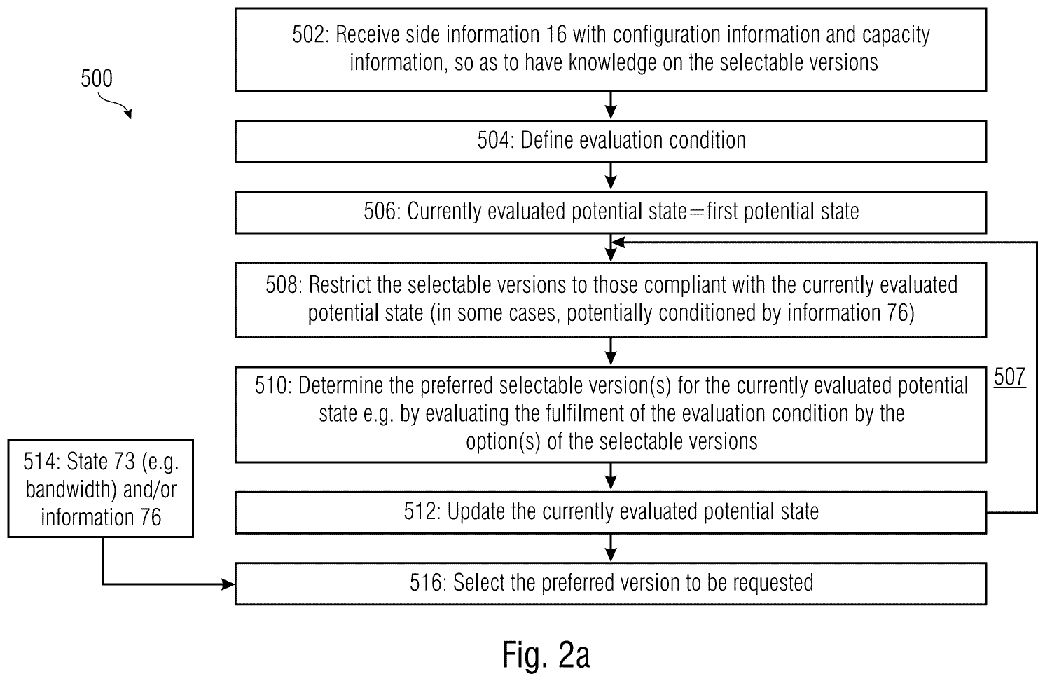

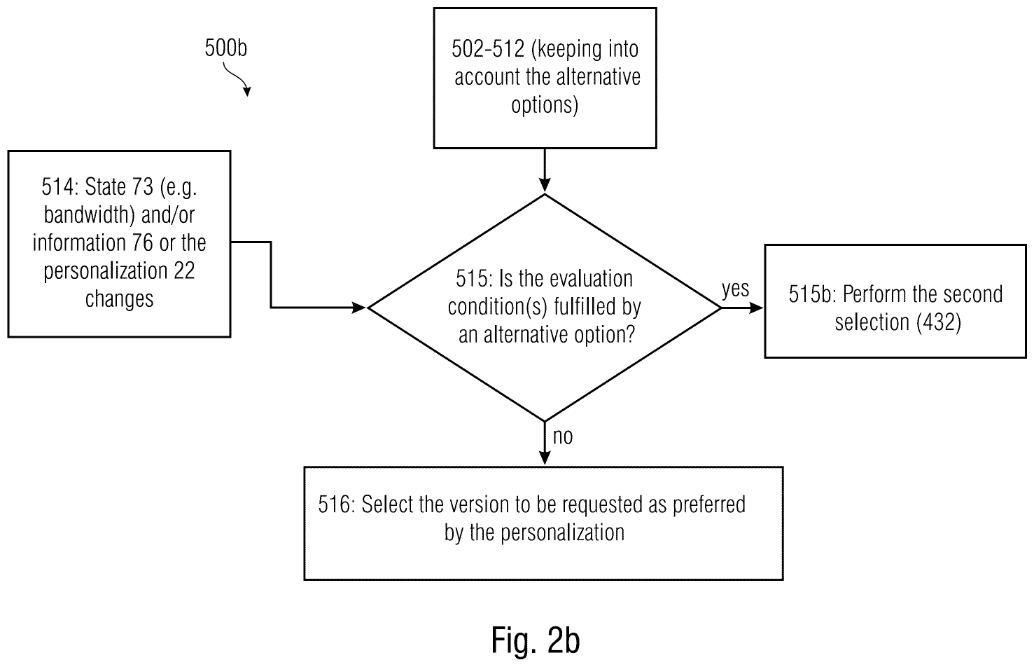

FIG. 3b shows a graphic of the evolution of the network state 73 (13) in time (time: in abscissa; network state, or bandwidth, in ordinate). Two particular values, as defined by the current personalization criterion (evaluation condition), are shown: a first threshold of 768 kbps (which is the threshold for the personalization criterion choices in FIG. 3a) and 2 kbps and 25 kbps (which is a non-used threshold which would be used for triggering the selection of the selectable version 2). As can be seen, up to the time instant t1, the selected version is the preferred version 1 (selectable version 4) because the bandwidth is over the threshold of 768 kbps. At time instant t1, the threshold of 768 kbps is reached, and subsequently the bandwidth is less than 768 kbps. Accordingly, the selected version will be the preferred version 2 (i.e. the selectable version 5). Therefore, the requested version (through request 19) will be the selectable version 5 at 2 kbps. This will change at instant t2, again, and, therefore, the network will be in the status 1 again and the selected version 32 will be the preferred version 1 (i.e. the selectable version 4). As can be seen, the value A=a2 of the personalization audio option is maintained, and therefore the personalization is respected. It is to be noted that FIG. 3b considers the delays due to the monitoring and the request (19) and the provision of the encoded audio signal according to the new selected version 32 (which of course requires some delay time) as being negligible (the time instance t1 and t2 should actually be slightly moved on the right in FIG. 3b).

FIG. 3a also shows that in the time interval between t3 and t4 (which are both intermediate between t1 and t2), the bandwidth goes below the 25 kbps. However, nothing changes, because the personalization 22 does not set any threshold at 25 kbps. A threshold is implicitly defined by the capacity threshold of 2 kbps but, in that case, there is no possibility of providing in time the bitstream 12.

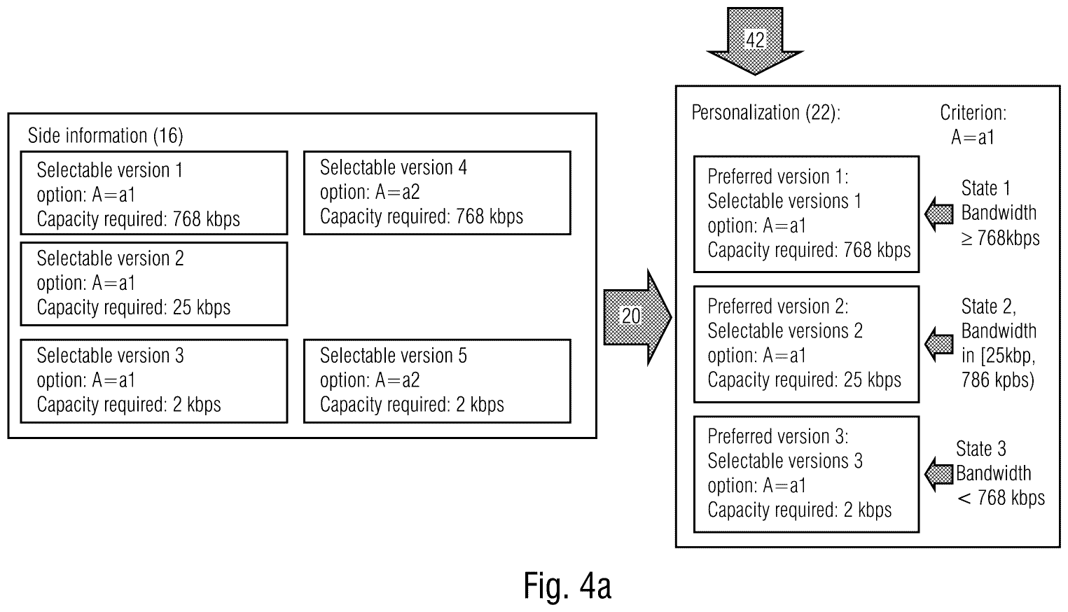

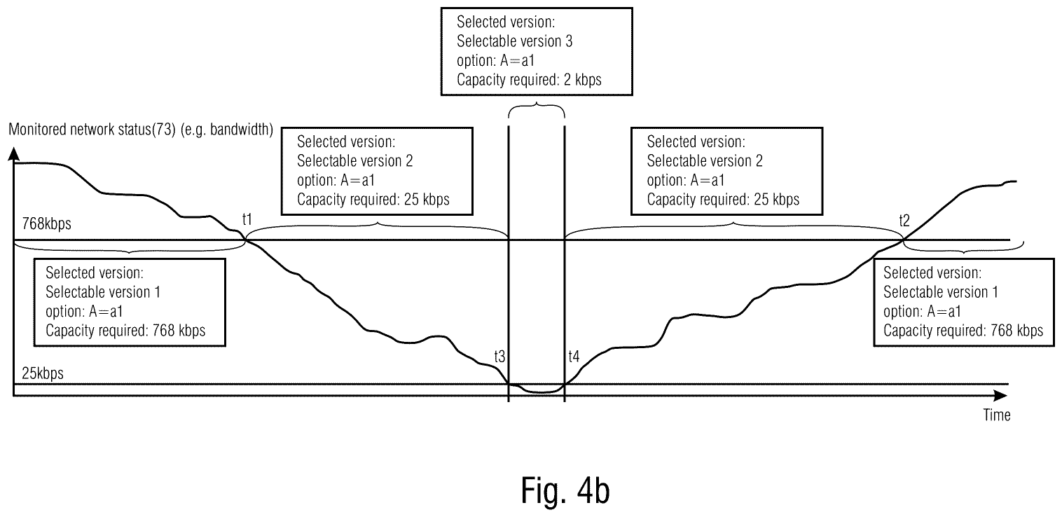

FIGS. 4a and 4b show the case in which the side information 16 is exactly the same as in FIG. 3a (the selectable versions, the options, and the capacities required are the same), and also the evolution of the network's bandwidth remains the same as in FIG. 3b. However, in this case, the personalization 22 is different, since the personalization criterion (evaluation condition) is A=a1, which will imply the selection of one of the selectable versions 1, 2, 3 instead of the selectable versions 4 and 5. In this case, the potential states of the external resource (bandwidth of the communication network) are three. Before t1, the selected version is the selectable version 1 (preferred version 1). Between t1 and t3, the selected version (preferred version 2) is the selectable version 2, since the bandwidth is between 25 kbps and 768 kbps. Between t3 and t4, the selected version (preferred version 3) is the selectable version 3, since the capacity required is at 2 kbps. Between t4 and t2 the selected version (preferred version 2) is the selectable version 2, since the capacity required is at 25 kbps. And, after t2, the selected version (preferred version 1) will be the selectable version 1, since the network's capacity is more than 768 kbps. As can be seen in FIG. 4a, the personalization criterion (evaluation conditions) is now based on the evaluation of two thresholds (25 kbps and 768 kbps) and it is now possible to also permit the user to enjoy the sound at 25 kbps between t1 and t3 and between t4 and t2. In this case, the lowest quality encoded audio signal according to the selectable version 3 will only be provisioned between t3 and t4. The personalization 22 is also respected.

In case the input 42 (e.g. if the user so requires) or 42d requires the change of the personalization criterion (e.g. from the personalization criterion A=a1 of FIG. 4a to the personalization criterion A=a2 of FIG. 3a), the personalization unit 20 will operate accordingly (e.g. changing the criterion and the preferred version) and the selector 30 will also select the versions accordingly.

As can be understood from FIGS. 3a-4b, the number of selectable versions is, for each potential state of the network, restricted by the personalization 22, so as a preferred version is defined for each potential state, and the selected version will be the preferred version which matches the state of the network. Without this technique, the bitstream 12 would not be selectable between option A=a1 and A=a2, and the user could not choose among them and could not update the choice during the reception of the same bitstream (scene).

Notably, in some examples, in the case in which at the encoder a new selectable version requiring capacity of 25 Kbps and with A=a2 suddenly comes at disposal, the configuration information may be transmitted in real time (e.g. synchronously) indicating the selectability of the new selectable version. At that reception, the personalization unit 20 can update the personalization 22 (e.g. in the case that the evaluation condition requires A=a2, the personalization 22 will have, as preferred version for the 25 Kbps, the new selectable version, and the selector 30 will consequently select the new version when the network state matches the capacity of 25 Kbps).

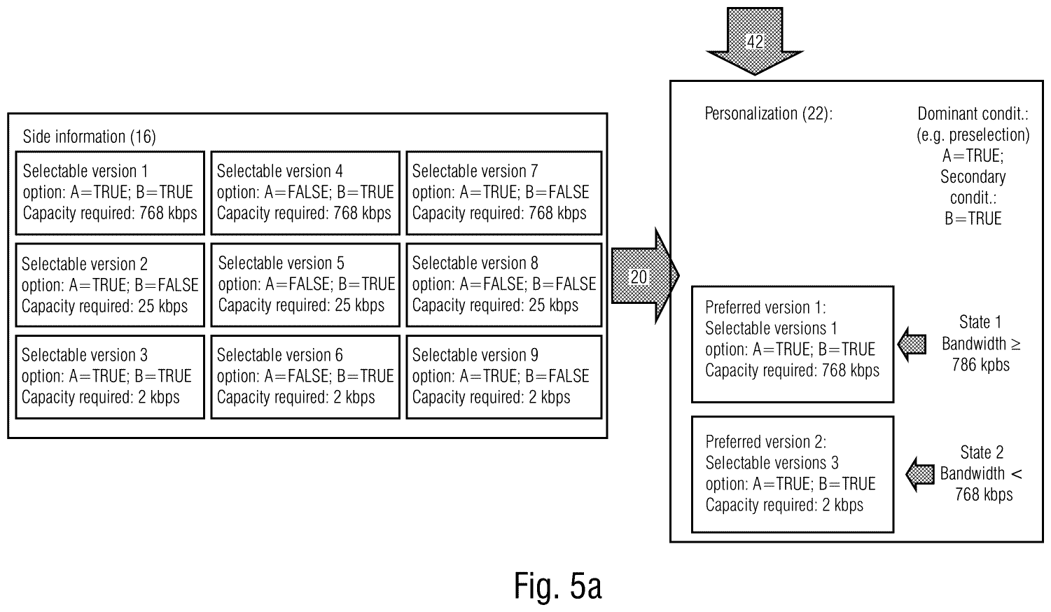

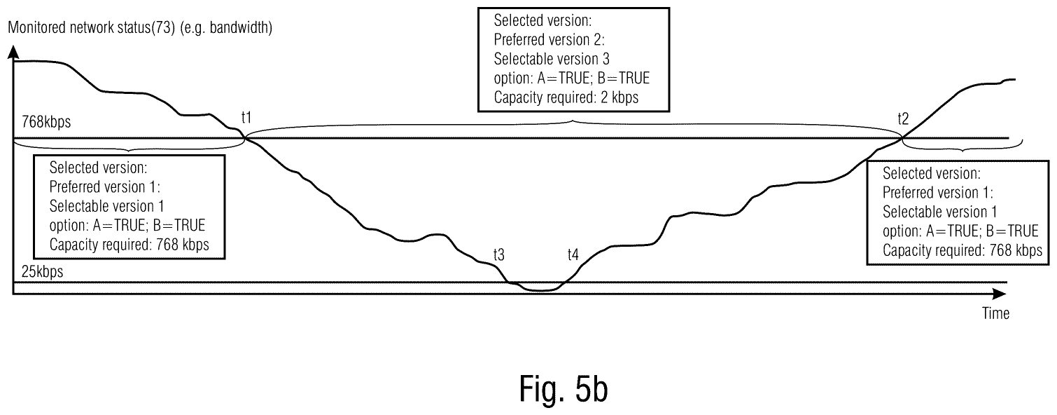

In an aspect according to FIGS. 5a and 5b, an example of personalization 22 has a dominant condition on a first audio option A (which is requested to fulfill the dominant evaluation condition A=TRUE) and a secondary (recessive) evaluation condition (which, according to the personalization criterion and/or the evaluation condition, it has to fulfill “B=TRUE”).

As can be seen, when the bandwidth is over 768 kbps (before t1 and after t2), the selected version is the selectable version 1. Indeed:
among all nine selectable versions, the selectable versions 1, 2, 3, 7, 9 are higher in the dominant ranking, because the dominant evaluation condition A=TRUE is verified, while the selectable versions 4, 5, 6, 8 are lower than the dominant ranking, because the dominant condition is here not fulfilled; and
in the secondary ranking, only versions 1 and 3 verify the secondary evaluation condition “B=TRUE” and are therefore preferred versions.

The selected version 1 matches the state of the network better than the selectable version 3 in case of high bandwidth (the acoustic bitrate of the selectable version 3 is extremely low), then the preferred version 1 to be selected in the state 1 when the bandwidth is ≥768 kbps, is the selectable version 1 (preferred version 1). On the other side, in case of the network is in the state 2 of the bandwidth being less than 768 kbps, then the selected version (preferred version 2) is the selectable version 3, because the selectable version 1 does not match the bandwidth of less than 768 kbps, and the remaining selectable versions 2, 5, 6, 8, 9 are lower in the dominant or recessive (secondary) rankings defined by the evaluation conditions (and/or personalization criterion). As can be seen in FIG. 5b that, before t1 and after t2, the selected version is the preferred version 1 (selectable version 1), while between t1 and t2, the selected version is the preferred version 2 (selectable version 3).

Therefore, the number of selectable versions is, for each potential state of the network, restricted by the personalization 22, so as a preferred version is defined for each potential state, and the selected version will be the preferred version which matches the state of the network. Once the personalization 22 is defined (based on any criterion), it is not necessary to evaluate the criterion anymore, but it is simply possible for the selector 30 to find the preferred version (among the preferred versions 1 and 2) whose capacity matches the state of the network.

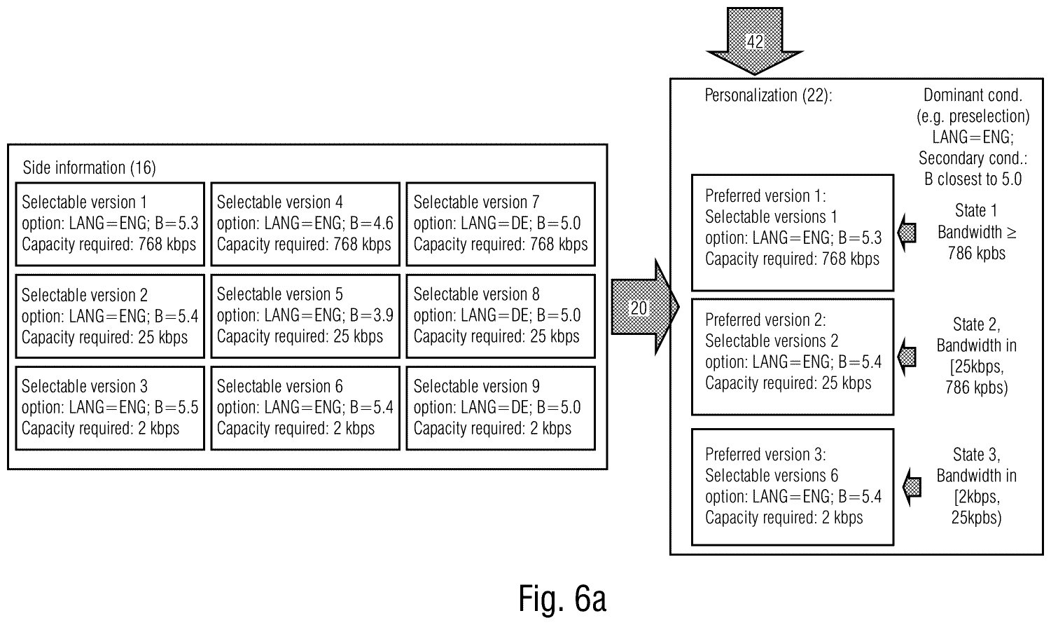

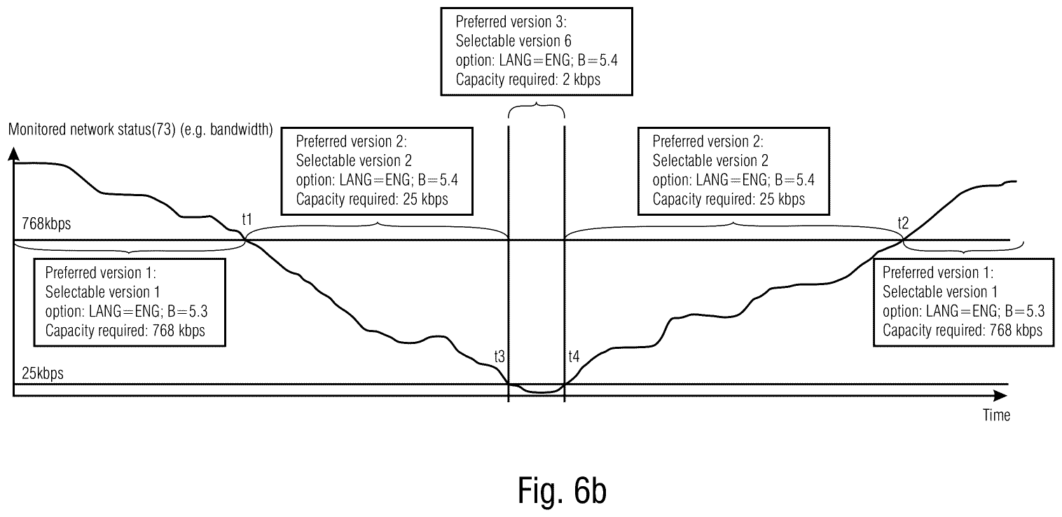

Another example is provided in FIGS. 6a and 6b. Here, a first personalization audio option is, for example, the dialogue language (abbreviated as “LANG”) which shall fulfil the dominant condition (e.g., a preselection), LANG=ENG; and a secondary “recessive condition” (personalization criterion) is in the numerical value of the personalization option B as closest to 5.0. As can be seen, in the case of bandwidth greater than 768 kbps the selected version will be the selectable version 1 because:
selectable versions 7, 8, 9 do not fulfill the dominant evaluation condition (and therefore, they are lower in the dominant ranking);
among the selectable versions 1, 2, 3, 4, 5, 6, which are higher in the dominant ranking, the selectable version closest to 5.0 (evaluation threshold) is the selectable version 1 (and therefore the selectable version 1 is highest in the recessive ranking).

Accordingly, before the time instant t1 in FIG. 6b, and after the time instant t2, the state 1 of the bandwidth as being ≥768 kbps is addressed by selecting the selectable version 1 (preferred version 1). In the state 2 between 25 kbps and 768 kbps, a second preferred version 2 is chosen among the selectable versions 2, 3, 5, 6, 8, 9, which are compliant with the bandwidth (selectable versions 1, 4, 7, have a too high bitrate and are therefore excluded). In this case, the dominant ranking puts versions 8 and 9 (having language being German) as lowest in the dominant ranking, and, among versions 2, 3, 5, and 6, the preferred version 2 is the selectable version 2, because its value B=5.4 is closest to the evaluation threshold 5.0 set by the secondary condition (selectable versions 3 and 5 are therefore lower in the ranking). Between selectable versions 2 and 6, the selected version is the preferred version 2, since it has a bitrate that better matches the network's bandwidth (the selectable version 2 has a better quality than the selectable version 6). Accordingly, between the time instants t2 and t3, the status 2 would be addressed by the preferred version 2 which is the selectable version 2. This also happens between time instants t4 and t2.

In case of bandwidth lower than 25 kbps, then the selected version (preferred version 3) can be chosen only among the group of selectable versions 3, 6, and 9 (because the other ones do not match the bitrate). However, the selectable version 9 is excluded, because the dominant condition of having the language English is not fulfilled by the selectable version 9. Subsequently, the secondary condition of the option B being closest to 5.0 (secondary evaluation threshold) is evaluated. Accordingly, the preferred version 3 is chosen as being the selectable version 6, since its option B=5.4 is closer to the threshold of 5.0 than the option B=5.5 of the selectable version 3. Accordingly, the status 3 of bandwidth between 2 kbps and 25 kbps between the time instants t3 and t4 is addressed by the preferred version 3 which is chosen as being the selectable version 6.

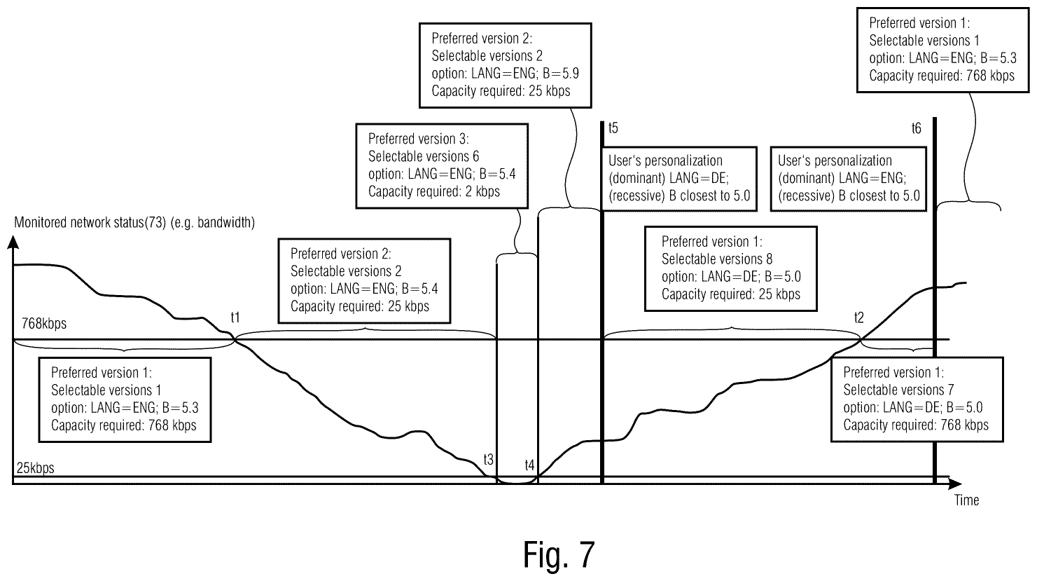

FIG. 7 shows the example of FIGS. 6a and 6b, but in this case, the preferred version is changed on the fly (and also the selected version is changed on the fly): in this case, the user decides to switch from dialog language English to dialog language German, and the actuation is represented to occur at instant t5. Before the time instant t5, the dialog language is English and the dominant condition and the secondary conditions (and the personalization 22) are the same as in FIG. 6a, and therefore, the graphic of FIG. 7 follows the graphic of FIG. 6b. Notwithstanding, at time instant t5, the user changes (e.g. through 42) the main evaluation condition changing the dialog language from English to German, while maintaining the secondary evaluation condition based on the closeness to the evaluation threshold 5.0. Accordingly, the personalization 22 is changed on the fly by the personalization unit 20 (the personalization shown in FIG. 6a is not valid anymore): now, as dominant condition, the dialog language shall be German, and this causes the selectable versions 7, 8, and 9 to be updated as being higher in the dominant ranking. In the secondary (recessive) ranking, all the selectable versions 7, 8, and 9 have the same option value B=5.0. Notwithstanding, after t5, the bandwidth is less than 68 kbps, and therefore the selectable version 7 (requiring more than 768 kbps) cannot have a high ranking in the ordering. Therefore, among the highest ranked selectable versions 8 and 9, the selectable version 8 (requiring 25 kbps) is selected, because it better matches the bandwidth. This situation changes in time instant t2, after which the bandwidth is over 768 kbps and, therefore, the preferred version becomes the selectable version 7. At the time instant t6, the user changes (e.g. though 42) the evaluation condition again and sets the dialog language to be English again. At this point, the personalization goes back to be as in FIG. 6a, and the selectable version 1 is now selected.

The number of selectable versions is, for each potential state of the network, restricted by the personalization 22, so as a preferred version is defined for each potential state, and the selected version will be the preferred version which matches the state of the network.

As shown above, for each potential state of the network there are plural selectable versions, but the number of selectable versions is restricted by the personalization 22, e.g. by choosing only one single preferred version for each potential state (and the final state to be received is selected by the selector 30 based on the particular state of the network).

FIG. 2a shows an operation 500 which may be performed by a streaming client device 100-100e. Operation 500 may include a step 502 of receiving side information 16 including configuration information and capacity information, so as to have knowledge of the selectable encoded audio signal versions. Then, there may be step 504 of defining the evaluation condition. Step 502 may be performed, for example, by the personalization unit 20 e.g. under constraints based on personalization input(s) 42 and/or 42d. There may be defined a step 506 of defining the current evaluated potential state as the first potential state of a group of potential states. For example, the different potential states may be, in the examples of FIGS. 3a-7, associated to the different bitrates at the ranges defined by the thresholds 768 kbps, 25 kbps, and 2 kbps. Therefore, the currently evaluated potential state may be the first to be evaluated (e.g., could be the state 1 over 768 kbps, for example). From here, a loop 507 e.g. among states 508, 510 and 512 may be performed, in which the preferred encoded audio signal versions are evaluated for the different potential states. There may be provided, in the loop, a step 508 of restricting the selectable encoded audio signal versions to those compliant with the currently evaluated potential state (e.g. potentially conditioned by information 76). This may be obtained, for example, by avoiding those selectable encoded audio signal versions which require capacity which does not match with (e.g. which requires more capacity than) the potential state (e.g., those that have a bitrate, which is too high for a particular capacity of the network or bandwidth). Hence, for all the selectable versions which match a potential state, only one preferred version (e.g., the highest-ranked version) may be chosen, thereby restricting the number of selectable versions that can be received for each particular potential state. Then, there may be a step 510 of determining the preferred selectable encoded audio signal version(s) for the currently evaluated potential state e.g. by evaluating the fulfilment of the evaluation condition by the personalization option(s) of the selectable versions. These operations may therefore perform at least one ranking (e.g., dominant rankings or rankings based on scores). Then, there is the step 512 of updating the currently evaluated potential state (e.g., from state 1 at bandwidth ≥768 kbps, another range of the bandwidth between 25 kbps and 768 kbps may now be currently evaluated). Therefore, for the new currently evaluated potential state, steps 508 and 510 are repeated. At the end of the update, there may be a step 514 of obtaining the state 73 (e.g., bandwidth) and/or information 76 (e.g., from capacity requirement conditioning units 75). Then, there may be a selection of the version to be requested at step 516. According to operation 500, there may be one or several preferred selectable versions for each potential state. The selector 30, at step 516, selects the preferred version according to the current capacity of the network and/or the information 76. Steps 504-512 may be performed by the personalization unit 20. In case a new configuration information is received (e.g. synchronously) the operation 500 may be reinstantiated from step 502.

Examples of FIGS. 3a-7 are mostly directed to the examples in FIGS. 1a-1e and are imagined as being performed in a case in which there are no personalization options which are alternative with each other. However, it is here admitted the possibility of having alternative options. Here below there are mainly discussed operations of the examples of FIGS. 10a-10e, e.g. involving the second selection 432 (with alterative options).

FIG. 11a shows an example in which, in case of maximum bandwidth (or maximum capacity at more than 768 kbps) a selectable version 1 has two alternative options, alternative with each other, i.e. dialog language being either English or German, and another selectable version 8 has two alternative options, i.e. language being either German or Spanish. At a lower capacity (between 25 kbps and 768 kbps) there are at disposal a selectable version 2 with only English, a selectable version 4 with only Spanish, and a selectable version 6 with only German. At the lowest capacity (under 25 kbps) there are at disposal a selectable version 2 with only English, a selectable version 4 with only Spanish, and a selectable version 6 with only German. The personalization 22 may require the choice of English (e.g., because the user has set, in personalization input 42, the use of English as dialog language), and therefore, the selected version (preferred version 1) is the preferred version for bandwidth ≥768 kbps, with second selection 432 being English. For bandwidth between 25 kbps and 768 kbps, the selected version (preferred version 2) is the selectable version 2 (because the selectable versions 4 and 6 don't have English); and for bandwidth lower than 25 kbps the selected version (preferred version 3) is the selectable version 3 (because the selectable versions 5 and 7 don't have English). The graphic in FIG. 11c shows the selections that are performed by requesting (through request 19) the different selectable versions 1, 2, 3. Let us explore in FIG. 11c the case in which the user, at instant t0<t1, changes the personalization input 42 from English to German. In this case, the personalization 22 changes (hence, the personalization 22 as shown in FIG. 11a is not valid anymore), but the preferred version remains the selectable version 1, because the selectable version 1 also has the option German. Hence, at instant to the dialog language is instantaneously switched (through 432) to German by deactivating English and activating German (which is alternative to English). There is no need for requesting (e.g. through request 19) a new stream including German. After t0, the selected versions will be those having German as option, thereby fulfilling the evaluation condition of having dialog language being German. At time instant t10>t2, it happens that the user sets once more the dialog language to English. Even in that case, the personalization 22 changes (and come back to be as in FIG. 11a), and the second selection 432 chooses English once again without requesting a new selectable version to the streaming server device (in the time span between t4 and t10, the English was notwithstanding received, although in latent, non-rendered form, e.g. non-decoded or non-transcoded).

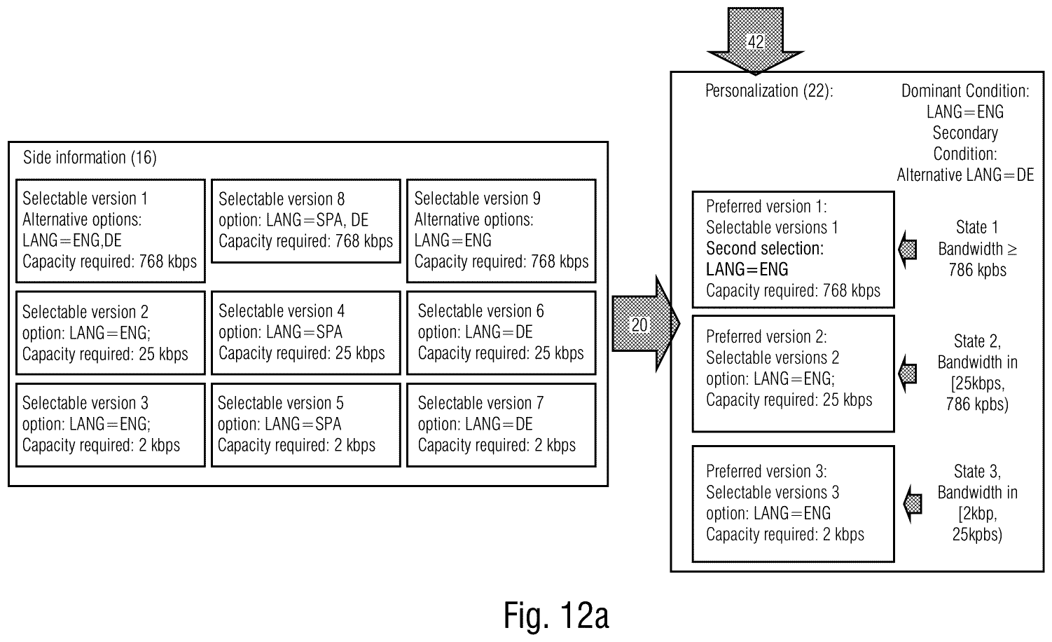

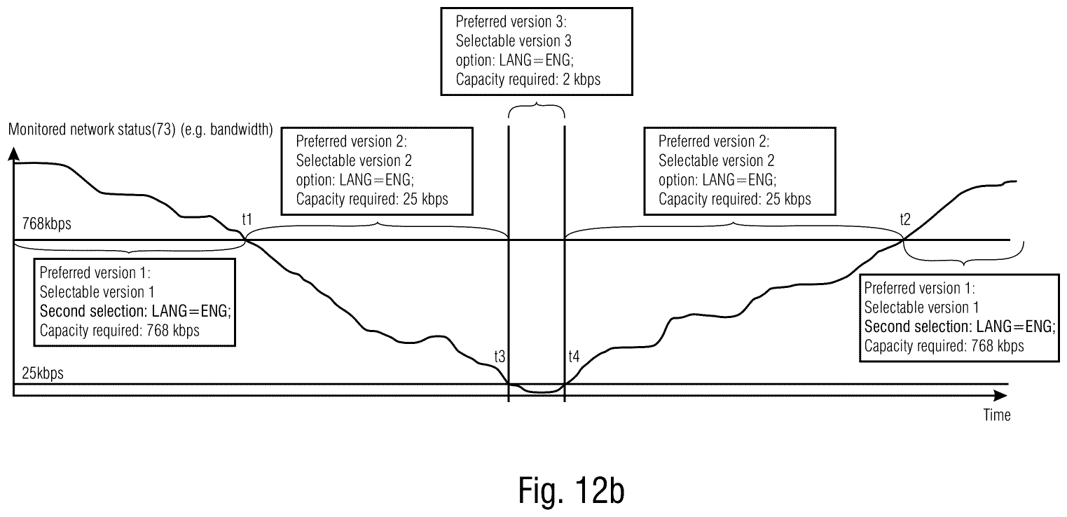

Another example is provided in FIGS. 12a and 12b. This example is substantially the same of that of FIGS. 11a-11c, but here, for the state of 768 kbps or more, there is one additional selectable version 9 only having English as dialog language. The selectable version 9 could also have a better quality than the selectable version 1, but the selectable version 1 can notwithstanding be preferred at the expenses of the selectable version 9. This may occur, for example, in the case of the personalization input 42 or 42d requesting:
as dominant condition, the dialog language to be English; and
as recessive condition, the dialog language to be German as alternative option.

The selectable version 1 fulfils both the dominant condition and the recessive (secondary) condition, because the selectable version 1 has both German and English, while the selectable version 9 des not fulfil the recessive condition, since it does not offer German. For this reason, the personalization is so defined that the selectable version 1 is the preferred version for bandwidth ≥768 kbps, despite the fact that the selectable version 9 could also have a better quality. The behavior of FIG. 11c is valid also for the example of FIGS. 12a and 12b when the personalization input 42 or 42d is changed as in t0 and t10. The case of FIGS. 12a and 12b may occur, for example, where a German user intends to watch a film in English: the film will be played back in English, and, in case the German user intends to switch to their mother tongue, this will be actuated immediately. For example, the dominant condition may be chosen by input 42, and the recessive condition may be chosen by 42d (pre-defined settings, given the fact that the device may be marketed in Germany).

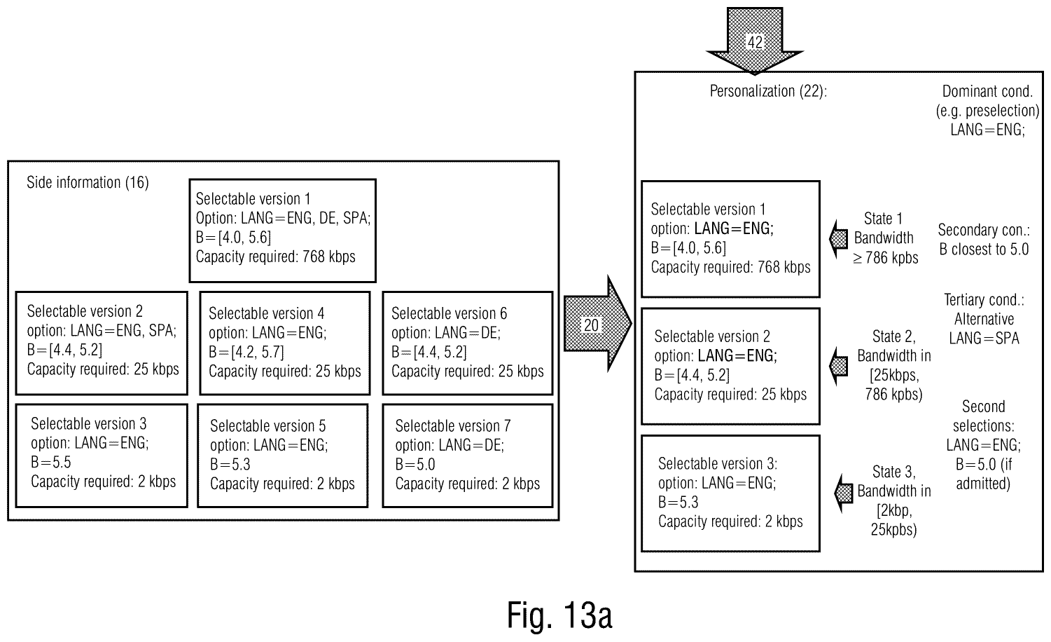

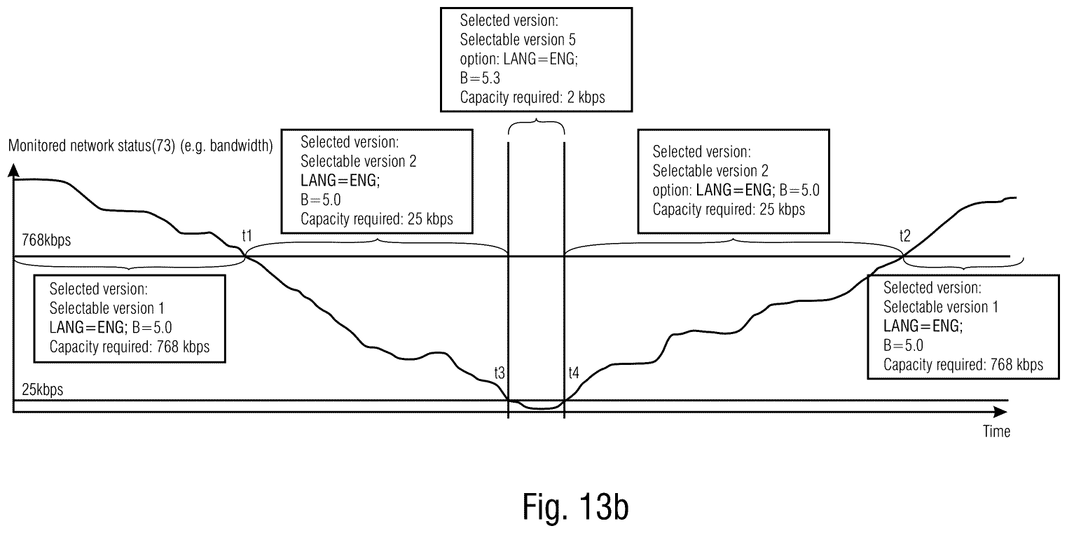

FIGS. 13a and 13b show another example. In this case, there are the following selectable versions:
1) For bandwidth ≥768 kbps:
   a. A selectable version 1 offering alternative options English, German, and Spanish, and another option B in a range [4.0, 5.6] (B could be a gain, an audio object position, or another audio or spatial magnitude)
2) For bandwidth in the range between [25 kbps, 768 kbps]:
   a. A selectable version 2 offering alternative options English and Spanish, and option B in a range [4.4, 5.2]
   b. A selectable version 4 offering only English, and option B in a range [4.2, 5.7]
   c. A selectable version 6 offering only German, and option B in a range [4.4, 5.2]
3) For bandwidth in the range under 25 kbps:
   a. A selectable version 3 offering only English, and option B only at 5.5
   b. A selectable version 5 offering only English, and option B only at 5.3
   c. A selectable version 7 offering only German, and option B only at 5.0.

Let us assume that the personalization input 42 and/or 42d is:
1) As dominant condition, language English
2) As secondary condition, B being 5.0 or at least as closest as possible to 5.0
3) As tertiary condition, the alternative language being Spanish.

Here, the personalization unit 20 will define the personalization 22 as follows:
1) for bandwidth ≥768 kbps, the preferred version 1 is the selectable version 1 (which is the only one selectable version requiring more than 768 kbps).
2) For bandwidth between 25 kbps and 768 kbps, the preferred version 2 is the selectable version 2, because, among the selectable versions 2, 3, 4, 5, 6, 7:
   a. In the dominant ordering (based on the dominant condition of the language being English), the highest ranking is awarded to the selectable versions 2, 3, 4, 5 (because selectable versions 6 and 7 do not have English)
   b. In the secondary (recessive) ordering (based on the secondary condition of having the value B as closest as possible to 5.0), the highest ranking is awarded to the selectable versions 2, 4 (because B=5.0 is in the range of the selectable versions 2 and 4, while B=5.0 is not in the range, or single value, of the selectable versions 3 and 5; the selectable versions 4 and 6 being already excluded in the dominant ordering)
   c. In the tertiary (most recessive) ordering (based on the tertiary condition of having Spanish as alternative option), among the selectable versions 2 and 4 the highest ranking is awarded to the selectable version 2, since it has also Spanish as alternative option (while the selectable version 4 has not Spanish, and the other selectable versions have already been excluded in the higher-level orderings)
3) For bandwidth under 25 kbps, the preferred version 3 is the selectable version 5, because, among the selectable versions 3, 5, and 7:
   a. The selectable versions 3 and 5 are awarded of the highest ranking in the dominant ordering (based on the dominant condition of the language being English), while selectable version 7 does not have English
   b. In the secondary (recessive) ordering (based on the secondary condition of having the value B as closest as possible to 5.0), the selectable version 5 (having B=5.3) is awarded of the higher ranking over the selectable version 3 (having B=5.5, which is more distant from the threshold 5.0 than the selectable version 5)

With reference to FIG. 13b, the selector 30 will operate as follows:
1) Before t1:
   a. the selector 30 will request (through a request 19) the selectable version 1, following the definition of the personalization 22
   b. further, the selector 30 will also set the second selection 432 by choosing the language to be English (which is offered by the selectable version 1), and the value of B to be 5.0 (which is also in the range [4.0, 5.6] offered by the selectable version 1)
   c. (advantageously, if the personalization input 42 or 42d is suddenly changed to have, as a dominant condition, the language to be Spanish, then the selected version will remain the selectable version 1, but the second selection 432 will switch onto Spanish, deactivating English, and avoiding a new active request 19 of a different selectable version)
2) between t1 and t3:
   a. the selector 30 will request (through a request 19) the selectable version 2, following the definition of the personalization 22
   b. further, the selector 30 will also set the second selection 432 by choosing the language to be English (which is offered by the selectable version 2), and the value of B to be 5.0 (which is also in the range [4.4, 5.2] offered by the selectable version 2)
   c. (advantageously, if the personalization input 42 or 42d is suddenly changed to have, as a dominant condition, the language to be German, then the selected version will remain the selectable version 2, but the second selection 432 will switch onto Spanish, deactivating English, and avoiding a new active request 19 of a different selectable version)
   d. (also advantageously, if the personalization input 42 or 42d is suddenly changed to have, as a recessive condition, B to be as closest as possible to 4.4, then the selected version will remain the selectable version 2, but the second selection 432 will switch onto having B=4.4, deactivating B=5.0, and avoiding a new active request 19 of a different selectable version)
3) between t3 and t4:
   a. the selector 30 will request (e.g. through request 19) the selectable version 5, following the definition of the personalization 22
   b. there is no second selection 432, because the only language option is English, and B is only provided uniquely at B=5.3
   c. (advantageously, if the personalization input 42 or 42d is suddenly changed to have, as a recessive condition B to be as closest as possible to 4.4, then the selected version will remain the selectable version 5, avoiding a new active request 19 of a different selectable version)
4) between t4 and t2, the selection 32 will be as between t1 and t3
5) after t2, the selection 32 will be exactly as before t1.

FIG. 2b shows an operation 500b which may be performed by any of the examples of FIGS. 10a-10e. The steps 502-512 may be performed as in the example 500 of FIG. 2a. FIG. 500b refers to the case in which the state 73 or the personalization 22 changes (514), e.g. by virtue of a command in the personalization input 42 and/or 42d, which may also change the personalization criterion and/or the evaluation condition(s). It is only to be noted, in that case, that, among the options, alternative options are to be taken into account (e.g., in recessive evaluation conditions): at step 515 it is evaluated whether the current evaluation condition(s) is fulfilled by the currently received encoded audio signal 14 (e.g., by an alternative option, currently deactivated and therefore not rendered or transcoded, by notwithstanding being currently received). In case the alternative option satisfies the evaluation condition(s), then a second selection 432 may be performed (at 515b) by the selector 30, so as to activate the alternative option(s) fulfilling the current evaluation condition(s), and the transmission of a new request 19 is avoided. Otherwise, at 516, a new selectable encoded audio signal version is selected and a new request 19 is sent to the streaming server device.

Since the examples above (e.g. in FIGS. 1a-1e and 10a-10e) may be understood as being mainly directed to the adaptive bitrate streaming, the bitrate 12 as provided by the streaming server device to the streaming client device 100 can change on the fly: the encoded audio signal 14 (or more in general the bitstream 12) may be divided in segments and, for each segment, a different encoded audio signal version (among the plurality of selectable encoded audio signal versions) may be provided. The selector 30, therefore, may operate on the fly, by requesting different audio signal versions in response to different states of the external resource (e.g., bandwidth provided by the network). Notably, however, the selector 30 does not simply select the audio signal version with the capacity matching the monitored state 73 (bandwidth at disposal of the bitstream 12), but also based on the personalization 22 as defined by the personalization unit 20. Therefore, there are at least the following consequences:
1. The selector 30 selects an encoded audio signal version which best matches the capacity (bandwidth) provided by the communication network (or more in general, the external resource). However, it is not always guaranteed that the highest bitrate version is actually selected by the selector 30. For example, the highest quality version (requiring the highest bitrate) could not be the preferred version (e.g., because a lower quality version better fulfills the personalization criterion and is chosen at the expenses of the highest quality version).
2. Even if this policy could appear to be disadvantageous (because the selected encoded audio signal version 32 has not necessarily the highest possible bitrate), notwithstanding, the user's selections are maintained.
3. If the communication network (or more in general, the external resource) transitorily suffers of a peak of low bandwidth (the bandwidth at disposal of the transmission of the bitstream 12 begin abruptly reduced), then the user will still enjoy the playback of an audio signal according to the personalization 22 (it will be the highest in the ranking for the new, low bandwidth).
4. The alternative (typical in conventional streaming techniques) would be that the user could experience the playback of an audio signal against the personalization 22, or that the transmission would suffer a discontinuity of the service, thereby not providing to the user any sound.
5. As soon as the resource (e.g. bandwidth) is abundant again, the selector 30 will select, once again, the preferred encoder audio signal version at the new current capacity (bandwidth) 73. Accordingly, as soon as the bandwidth 13 is in good state, the user will experience, once again, a sound at the highest possible quality compliant to the personalization 22.
6. The streaming client device 100-100e, 400-400e also permits a transparent change of the resource (e.g., the communication network may be changed without the user to even know it). For example, if the communication network includes a broadband connection (e.g. through Wi-Fi) for playback in the user's smartphone (the smartphone embodying the streaming client device 100), then the user can experience the sound at the highest quality compliant with the personalization 22. As soon as the user leaves the area covered by the broadband connection (e.g. the user leaves home and the smartphone 100 needs to rely on a less performing mobile-phone network), then the transition towards a low bitrate encoded audio signal version will be selected by the selector 30 (based on the personalization 22) and will be requested (19) by the communication interface 10.
7. Moreover, in case the bandwidth is enough, personalization options may be latently received but not rendered, e.g., based on recessive, secondary evaluation conditions defined, and their actuation will be immediate in case the personalization input suddenly changes.

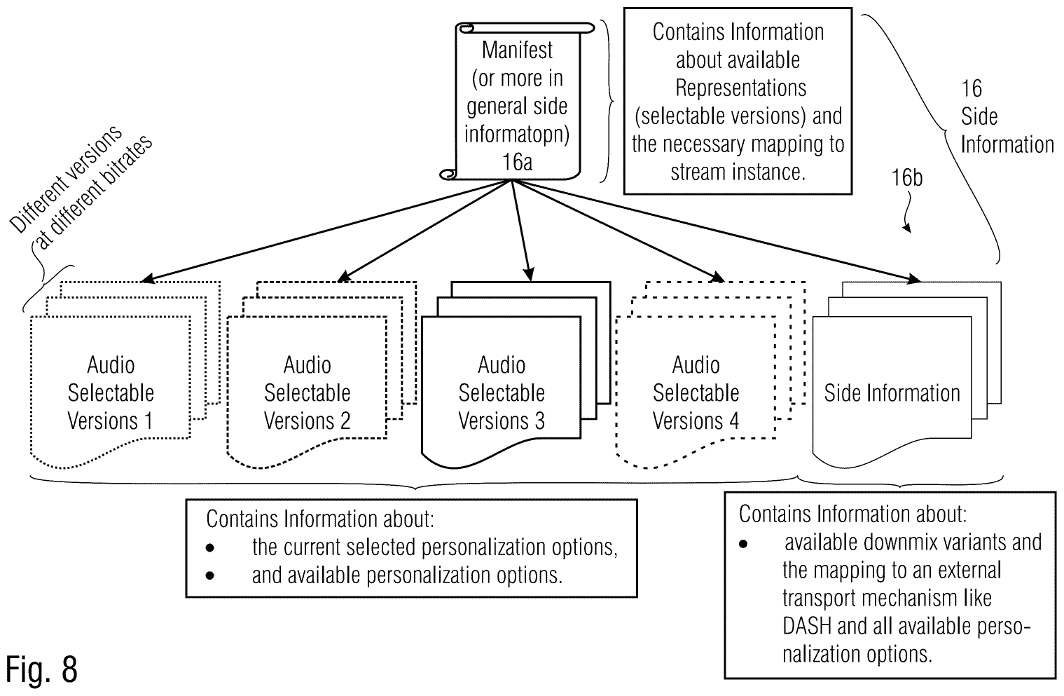

FIG. 8 shows an example of side information 16. In some cases, the side information 16 may include at least one of a preliminary side information 16a (which may be transmitted from the streaming server device to the streaming client device 100-100e at the initial stage of the transmission of the bitstream 12) and an updating side information 16b (which may be transmitted from the streaming server device to the streaming client device 100-100e in parallel to the transmission of the selected encoded audio signal 14 of the bitstream 12). The preliminary side information 16a may permit the personalization unit 20 to perform the first instance of the personalization 22. When implemented, the updating side information 16b may permit to update the personalization 22 (and/or the selection) on the fly. The preliminary side information 16a may include a manifest which may be a part of the side information (configuration information) 16. The manifest may be a file in MPD format and/or may be a DASH-MPD (dynamic adaptive streaming HTTP media presentation description) format. The manifest file may contains Information about available representations (selectable encoded audio signal versions). The mapping to the particular selectable encoded audio signal version may also be indicated, so as to let the communication interface 10 to be aware of how to address, in the request 19, the selected version 32. As can be seen, for each selectable encoded audio signal version, there may be several codecs at disposal. The particular codec may be a first option of the selectable encoded audio signal versions. For each codec, there may be at least one different audio representations (selectable encoded audio signal versions). For each version, the side information (in the manifest) may contain information about the current selected personalization options and available personalization options. Updating side information 16b, e.g. carrying updated configuration information, may comprise information on the current audio representation with interactivity options and information on the personalization (e.g., it may be sent synchronously to the encoded audio signal, and the personalization 22 may be changed in real time based on the updated side information 16b). Further side information (independent on the codec) may include information about available downmix variants and the mapping to an external transport mechanism like DASH and all available personalization options.

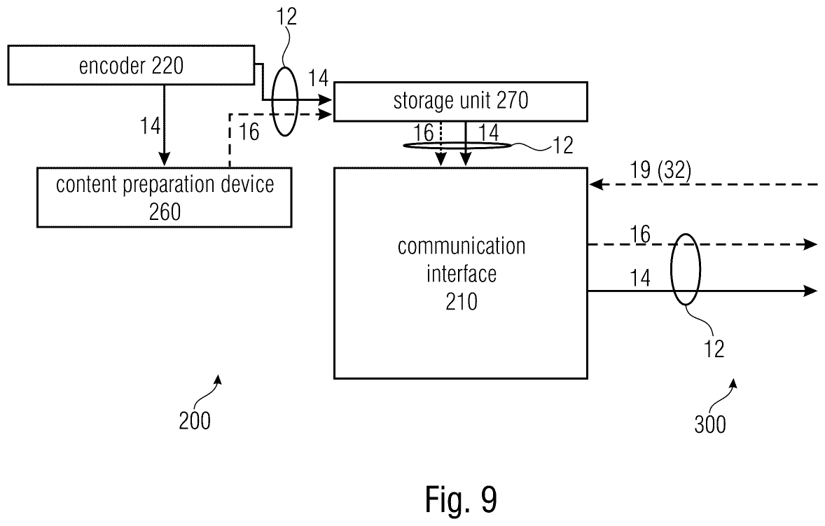

FIG. 9 shows an example of a streaming server device 200 which may transmit the bitstream 12 towards the streaming client device (100-100e, 400-400e etc.) as above. All the properties of the bitstream 12 (encoded audio signal 14 and/or side information 16) as transmitted by the streaming server device 200 may therefore be obtained from the description above, and are therefore not repeated here. The streaming server device 200 may comprise a communication interface 210. The communication interface 210 may transmit the bitstream 12 to the streaming client device (100-100e, 400-400e etc.). As explained above, the bitstream 12 may be segmented according to a plurality of segments, e.g. independently decodable segments, and having an encoded audio signal 14 and side information 16. The communication interface 210 may receive a request 19 of a selected audio signal version of the bitstream (12), so as to transmit the bitstream (12) according to the selected encoded audio signal version (32) starting from a subsequent segment to be transmitted, each of the encoded audio signal versions requiring a predetermined capacity and being according to at least one personalization audio option (e.g. according to a set or combination of personalization audio options). Multiple encoded audio signal versions 14 may be generated by the encoder 220, e.g. at different qualities (e.g., bitrates, number of spatial channels, etc.). The streaming server device 200 may include a content preparation device 260 which may associate each encoded audio signal 14 to personalization options. The content preparation device 260 may associate personalization options to the selectable encoded audio signal versions 14 and embed side information 16 to them. For each encoded audio signal version 14, the side information 16 may be generated so as to provide configuration information regarding the personalization options offered by the current encoded audio signal version 14 and by the other, selectable encoded audio signal versions 14. The personalization options may be listed, e.g. together with the indication whether they are deactivatable and/or whether they are alternative to other ones. Further, the side information may include capacity information indicating the capacity required, by the network, for the transmission of the current encoded audio signal version 14 and/or the other encoded audio signal versions 14.

The streaming server device 200 may operate according to the techniques of the adaptive bitrate streaming. The streaming server device 200 may comprise a storage unit 270 in which multiple encoded audio signal versions are stored. The selected audio signal version 32 as requested (19) by the streaming client device (100-100e) may therefore be provided. At each start of a new segment of the encoded audio signal version to be transmitted to the streaming client device (100-100e, 400-400e) the communication interface may detect whether an updated selected audio signal version 32 is requested (19) by the streaming client device (100-100e, 400-400e), so that the updated selected audio signal version 32 is provided as current encoded audio signal 14 at least for the subsequent segment (in case of absence of updating request 19, the streaming server device 100 may transmit the subsequent segment according to the same selected audio signal version 32 as requested in the last request 19). In examples, at least one encoder 220 encoding at least one encoded audio signal version may be part of the streaming server device 200. In examples, the at least one encoder 220 may operate offline. In some other examples, the at least one encoder 220 may operate in a feedback fashion, thereby modifying the at least one personalization audio option or set or combination of personalization audio options on the fly, based on the request 19. In particular in this case, the encoded audio signal version may be non-pre-stored in the storage unit 270, but may be encoded on demand based on the request 19.

The streaming server device 200 may comprise:

A bitstream or side information interface configured to:
Embed the complete set of all possible personalization options to the bitstream of each encoded audio signal version and/or
write the complete set of all possible personalization options as side information of each encoded audio signal version.

The streaming server device 200 may comprise a bitstream or side information interface configured to:
embed, in the configuration information of the side information, available (sub) set of possible personalization options or the personalization option provided by the encoded audio version to the respective bitstream of each encoded audio signal version and/or
write the available (sub) set of possible personalization options or the personalization option provided by the encoded audio version as side information of each encoded audio signal version.

In the present examples, it is possible to jump from one codec to another one. For example, one bitstream (including the encoded audio signal and the side information) may be according to a first codec, and different selectable audio signal versions (including the encoded audio signal and the side information) may be encoded according to a different codec. Anyway, it is possible to jump from one codec to another one (e.g., under the request 19 sent by the streaming client device 100-100e, 400-400e). For example, it is possible to jump from MPEG-H 3D Audio to MPEG-D USAC (or vice versa), or to remain in the same codec, according to the choices of the personalization unit 20, the selections operated by the selector 30, and/or the personalization input 42 or 42d (e.g., commanded by a user). The encoded audio signal (16) may be according to codec MPEG-H 3D Audio and/or MPEG-D USAC (Extended HE-AAC), and the current encoded audio signal version may be according to MPEG-H 3D Audio, and the other selectable encoded audio signal versions are encoded either using MPEG-H 3D Audio or MPEG-D USAC, Extended HE-AAC, wherein the bitstream or side information is according to MPEG-H 3D Audio or MPEG-D USAC, Extended HE-AAC (or vice versa). In alternative, the encoded audio signal (16) may be according to codec MPEG-H 3D Audio, and the other selectable encoded audio signal versions may be according to codec MPEG-H 3D Audio, the bitstream and/or side information being embedded according to MPEG-H 3D Audio.

In examples above, at least one personalization option may include at least one of position data, audio object selection, gain level (which may be in a particular range offered by the particular selectable encoded audio signal version). At least one personalization option may include position data (e.g. the position of the user, or the position of an audio object). At least one alternative personalization option may include an audio object selection, such as a group of audio objects/channels were only one at a time is active (for example the main dialogue of an movie). At least one activatable or deactivatable personalization option may include muting and unmuting of specific audio object. At least one personalization option may include mixing values for components of the encoded audio signal. At least one activatable or deactivatable personalization option may include information on selection and deselection of components of the encoded audio signal. At least one activatable or deactivatable personalization option may regard information used to influence the rendering of components of the content.

It is to be noted that, in particular in the examples of FIGS. 10a-10e, when it is changed (e.g. through the second selection 432) to a different alternative option, it is advantageously possible, in some examples, to migrate seamlessly, by gradually deactivating the current option (e.g. in one channel) and gradually activating the subsequent option (e.g. in one different channel).

It is also to be noted that, with the present technique, once the personalization 22 is chosen, the reception of the encoded audio version may be basically managed in a loop between the communication interface 10, the selector 30, and the monitoring unit 70. In case the personalization 22 changes (either by virtue of new selectable versions as indicated by the configuration information or by virtue of a user's changed selection), the personalization 22 will be updated by the personalization unit 20 (e.g. operating like in an interrupt, exiting from the loop between the communication interface 10, the selector 30, and the monitoring unit 70), and the subsequent receptions will also be managed by the loop between the communication interface 10, the selector 30, and the monitoring unit 70, but with different personalization 22.

It is to be noted that, in any of the examples of FIGS. 3a-7 and 11a-13b, it may be that one high-capacity requiring version may be according to one codec, and one-low-capacity requiring version is according to a different codec.

In examples, the high-capacity requiring version may be, for example, a NGA version, while the low-capacity requiring version may be a legacy version. For this reason, it is possible to maintain the compatibility between the two codecs, and to switch from one codec to another codec seamlessly. It is to be noted that the beforementioned compatibility may include the capabilities to preserve the personalization state, i.e. the personalization 22 as chosen by the personalization unit 20.

In examples above, the encoded audio signal may be according to a first codec (e.g. MPEG-H 3D Audio), and other selectable encoded audio signal versions (or more in general other selectable encoded audio signal versions, selectable in alternative to the first selectable encoded audio signal version, e.g. for a different state of the external resource, e.g. for less bandwidth) are encoded using a second codec (e.g. MPEG-D USAC, Extended HE-AAC). (The side information may be according to MPEG-H 3D Audio or MPEG-D USAC, Extended HE-AAC, or another technique.) It may be possible to switch, e.g. in case the bandwidth is reduced, to switch the selection to one of the other selectable encoded audio signal versions.

The currently transmitted encoded audio signal (or more in general the currently received selectable encoded audio signal version) may be encoded using a second codec (e.g. MPEG-D USAC, Extended HE-AAC), and other selectable encoded audio signal versions (or more in general other selectable encoded audio signal versions, selectable in alternative to the first selectable encoded audio signal version, e.g. for a different state of the external resource, e.g. for more bandwidth) may be according to a first codec (e.g. MPEG-H 3D Audio). Therefore, it may be possible, e.g. in case the bandwidth is increased, to switch the selection to one of the other selectable encoded audio signal versions.

It is possible to switch from one currently receiver selected encoded audio signal version (first selected encoded audio signal version) (e.g. encoded according to a first codec, e.g., NGA) which requires a higher capacity but provides more personalization options, to a second selectable encoded audio signal version, which requires less capacity but provides less personalization options, and/or vice versa, according to the state of the external resource (e.g. network). The personalization may define that:
for a first state (e.g. higher bandwidth) of the external resource, the preferred encoded audio signal version is the first encoded audio signal version provided that the capacity required by the first encoded audio signal version matches the first state, and,
for a second state (e.g. lower bandwidth), the preferred encoded audio signal version is the second encoded audio signal version provided the capacity required by second first encoded audio signal version matches the second state.

The preferred encoded audio signal version for the second state may be the encoded audio signal version which, among those matching with the second state, most corresponds to the personalization options of the currently receiver selected encoded audio signal version (first selected encoded audio signal version). In order to decide which is the personalization option of the second state, the personalization unit 22 may make use of the side information configuration information. Based on the received side information (and in particular on the received configuration information), the personalization 22 (e.g. as defined by the personalization unit) may define, as preferred version for the second state (e.g. lower bandwidth), the second encoded audio signal version (e.g. among the other encoded audio signal versions which match the same second state). Based on the personalization 22, the selection 42 (e.g. as performed by the selector 40) may select, as soon as the second state of the network (e.g. lower bandwidth) is detected, to select the second version to be transmitted from the server device. A correspondence between the personalization options (e.g. preset(s)) of the first version and the personalization options of the second versions may be defined (e.g. by the personalization unit 20, e.g. keeping into account the personalization criterion and/or the evaluation condition), so that the personalization options chosen for the first version (in a state with higher bandwidth) are not lost for the second version.

It is possible to switch from one first selected (and currently transmitted) encoded audio signal version (e.g. encoded according to a first codec, e.g., NGA) which has at least one deactivatable personalization option and/or which gives the possibility of performing a local, second selection (e.g. as above), to a second encoded audio signal version (e.g. encoded according to a second codec, e.g. Extended HE-AAC, or a legacy codec), which has not deactivatable personalization options (or which has less deactivatable personalization options than the first encoded audio signal version) and/or which does not give the possibility of performing at least one second, local, selection (or which permits an inferior number of second, local selections), and/or vice versa. Considering that the first selected (and currently transmitted) encoded audio signal version may require more capacity than the second encoded audio signal version, the personalization 22 may define that, for a first state (e.g. higher bandwidth) of the external resource (e.g. network) 13, the preferred encoded audio signal version to be selected is the first encoded audio signal version (provided that the capacity required by the first encoded audio signal version matches the first state), and, for a second state (lower bandwidth) of the external resource, the preferred encoded audio signal version to be selected is the second encoded audio signal version (provided the capacity required by second first encoded audio signal version matches the second state).

The personalization 22 may be defined based on correspondences between the personalization option of a first encoded audio signal version (e.g. requiring more capacity and/or providing more personalization options, more second selections, and/or more deactivatable selections) and personalization options of at least one second encoded audio signal version (e.g. requiring less capacity and/or providing less personalization options or no personalization option at all, less second selections or no second selection at all, and/or less deactivatable selections or no deactivatable selection than the first encoded audio signal version): therefore, it may be chosen, as preferred encoded audio signal version whose capacity matches a second state (e.g. with less bandwidth), the second encoded audio signal version and, as preferred encoded audio signal version for a first state whose capacity matches a first state (e.g. with higher bandwidth), the first encoded audio signal version.

It is now understandable that, for each state of the external resource, the selector can select the encoded audio signal version (for the particular current state) which is the preferred encoded audio signal version for the particular state. The personalization may perform a reduction of the group of encoded audio signal versions which are actually selectable by the selector. Therefore, the selection 42 may not only select the most adapted encoded audio signal version (among a group of versions matching a particular state) by keeping into consideration the required capacity, but also by taking into account further options (e.g. preselected by the user or other preselections, or anyway by the personalization unit). For each current state, the selected encoded audio signal version which is selected may be the preferred version. While for each state of the external resource there may be more than one selectable version whose capacity matches the state, for each potential state there may be one single preferred version (e.g. restricted from all the capacity-matching selectable versions), and for each current state the selected version may be the one, among the all preferred versions defined by the personalization, which matches the current state. Hence, the selector 42 may base its selection on the personalization 22 of the selected encoded audio signal version based on the current state of the external resource and the preferred encoded audio signal version chosen by the personalization unit for the particular current state of the external resource (e.g. network).

### DISCUSSION

Next Generation Audio (NGA) systems such as MPEG-H 3D Audio enable various personalization and content-based interactivity features. This enables better accessibility to content, for instance through Dialogue Enhancement, or adaptation of the content to personal preferences, for instance through a selection between different content versions, including options for fine tuning those selections. Personalization can be enabled in the playback devices (e.g. mobile device, streaming client, etc) and is content driven, i.e. the options that are available in the playback device are controlled through the content, are authored during production and can potentially change from one piece of content to another.

Additionally, modern audio codecs, NGA as well as traditional channel-based codecs, e.g. Extended HE-AAC, enable seamless adaptive bitrate switching that allows the client to select the one version from a set of representations that fits best to the currently available network bandwidth. This selection can be changed over time to adapt to changing network conditions. The switch between representations normally happens at fragment boundaries (switch points) while decoding of the bitstream and audio output continues seamlessly.

Audio codecs like MPEG-H 3D Audio or Extended HE-AAC (USAC) enable seamless switching between two representations that are encoded at different bitrates through a feature that is called “Immediate Playout Frame” (IPF, U.S. Pat. No. 10,614,824 B2). A switch can be performed at IPFs given that the crossfade flag is set, the IPF distance for both streams is aligned, and the system is capable of performing a crossfade using the flushed output of the old stream and the IPF output of the new stream. Furthermore, it is important to render the output to the same target layout (output channel configuration) on decoder side.

In principle, the concept of IPFs also allows that the two (or more) representations are encoded using different codecs, like MPEG-H 3D Audio or Extended HE-AAC. If one of the codecs has a different output channel configuration, empty audio channels could be inserted and the crossfade would then translate to a fade-in or fade-out, depending on the direction of the switch.

The seamless adaptive switching of conventional technology as described here above works under the condition that the content authoring is identical for all representations that are encoded at different bitrates. This can be achieved for traditional channel-based content (like stereo or 5.1), i.e., the content is mixed into one single channel representation during production. For stereo content Extended HE-AAC enables bitrates as low as 12 or 16 kbps so that a client can switch down to those very low bitrates under bad network conditions.

However, for complex NGA content, authorings that include a high number of audio objects or signals and many personalisation options, the above condition regarding identical authoring for all conditions might not be true anymore. For instance, MPEG-H 3D Audio at Level 3 allows up to 16 audio objects/signals in various combinations and an “Audio Scene” that combines those signals in up to 8 “Presets” based on the concrete authoring. Each of these Presets might offer advanced personalization options, again based on the concrete authoring. All those 16 audio signals would need to be encoded for all representations to keep all personalization options and thus the content authoring identical across all representations. The lowest feasible bitrate for such a 16 audio signal representation might be e.g. as high as 250 kbps, which would be too high for certain network conditions. Therefore, there is the risk that seamless streaming of personalized NGA content is not possible anymore in such scenarios and the playout needs to be paused until the network recovers.

As the bitrate depends on the number of audio signals that need to be encoded, a mix down of such NGA content in representations with a lower number of audio signals would be necessary for lower bitrates, like those mentioned above. However, such a mix down compromises the authoring and thus the personalization options, up to the extreme case of a stereo downmix (or even a mono downmix) of the “Default Preset” with no personalization options at all.

On the other hand, the latter case of a stereo representation might be necessary to achieve the same low bitrates for bad network conditions as described above for channel-based content.

Consequently, adaptive streaming under all network conditions, down to very low bitrates, while keeping personalization is currently not possible. Content providers need to take the risk of a compromised consumer experience, either because of drop-outs during bad network conditions or because of unexpected changes regarding personalization.

In principle, all “Presets” that are authored for a piece of NGA content could be downmixed to separate, new content items that could then be encoded as stereo representations, either with the same NGA codec, or a different channel-based codec, as described above. However, there is currently no solution available that enables the streaming client to identify the correct version, respectively the best matching downmixed version, that fits best to the current user selection (personalization).

To solve this problem, additional information needs to be added to the NGA content, as well as to the downmixed versions that enable unique identification of those versions, more specifically to e.g. link them to the corresponding Preset, or in general to a personalization option, of the NGA content.

This additional information in the form of metadata (e.g. configuration information) may be inserted into the bitstreams, as well as on file format resp. manifest level (MPD), in the NGA content, as well as in the stereo representations. This information, typically the one on manifest/file format level, enables the streaming client to select the best matching representation in case it needs to switch down to a lower bitrate. In the case that the network conditions recovered, this metadata also enables the streaming client to switch up from a stereo representation to the NGA content. This metadata, in this case typically the one on bitstream level, also enables the receiving devices, more specifically the user interface (UI) manager (e.g. comprising at least one of personalization unit 20, selector 30, and user interface 40), to automatically select the best matching personalization option of the NGA content, and, for instance initialize the decoder through “user interaction packets”, respectively.

In the following, the solution is considered to be based on MPEG-H 3D Audio as NGA codec for delivering immersive and interactive content and on Extended HE-AAC as channel-based audio codec, that specifically is optimized on delivering the best audio quality for very low bitrates. However, it may be implemented also in other codecs and/or techniques. The given syntax and semantics of the described are only meant as examples how the functionality can be added to bitstream, file format or manifest elements.

The inventive solution will help to combine both technologies in a way that there can be a seamless transition between the Extended HE-AAC codec and the MPEG-H 3D Audio codec in, for example, an adaptive streaming environment.

It is noted, that in principle, the solution can also be applied to any other NGA codec, as well as to any other channel-based codec.

An example use case would be as follows: While being at home a user receives a 7.1+4 MPEG-H 3D Audio bitstream with 768 kbps through a broadband connection and WiFi for playback on the smartphone (using binaural rendering for headphone playback). As soon as the user leaves the home, a seamless transition to a stereo 24 kbps Extended HE-AAC stream could be performed (based on the quality of the mobile internet connection) so that the playback continues without interruptions.

As described, the bitrate adaptation itself can be handled as defined by U.S. Pat. No. 10,614,824 B2. However, MPEG-H 3D Audio defines several levels of user interactivity, which might result in a bad user experience if not handled properly. For example, an MPEG-H 3D Audio stream defines Presets, which can be explained as pre-configured user experiences. They are signalled as Preselections (ISO/IEC 23009-1) on MPD level. For MPEG-H 3D Audio, a user might select a certain Preset, e.g., with a different main dialogue language. If a switch to a stereo representation, encoded with a channel-based codec, e.g., Extended HE-AAC, is performed without special handling, the user-selected Preset will not be preserved, resulting in a bad user experience.

This can be addressed by encoding every Preset of the MPEG-H 3D Audio stream (identified by mae groupPresetID, ISO/IEC 23008-3) with a corresponding stream, encoded with a channel-based codec and down-mixed where required (e.g. first level of interactivity). For example, an MPEG-H 3D Audio stream with five Presets will result in five different streams encoded with Extended HE-AAC and allows a client to request the right stream based on the selected Preset.

The same process may be performed if a downmix (e.g. selectable encoded signal version) is required but encoded using MPEG-H 3D Audio, since the Audio Scene Information of the downmixed content does no longer contain user interactivity information.

Depending on the use-case, this concept might be extended for the second level of user interactivity with so called MPEG-H 3D Audio Switch Groups. A switch group (identified by mae switchGroupID) (it could be the second level of interactivity) contains multiple audio objects/groups from which exactly one (identified by mae_swichtGroupMemberID) can be active at a time. Therefore it might make sense to also take the mae_swichtGroupMemberID of one or more switch groups into account for stream selection.

Stream packagers (at the server device, and more in detail at the encoder) may need to understand the above mapping to generate manifest files reflecting the mapping (see Transport Format Signalling below). Respective signalling information is required in the bitstream encoding the down-mixed version of the content. For Extended HE-AAC, a USAC Configuration Extension (ISO/IEC 23003-3) can be used (see USAC Configuration Extension below). For MPEG-H Audio (ISO/IEC 23008-3), this can be achieved using a Configuration Extension and/or a respective MHAS Packet (see Configuration Extension and MHAS Packet below).

### Potential Example of USAC Configuration Extension to Signal Available Downmix Personalization

```
ISO/IEC 23003-3 Table 27:
  case ID_CONFIG_EXT_STREAM_ID:
    streamId( );
    break;
  case ID_CONFIG_EXT_PERSONALIZATION_MAPPING:
    personalizationMapping( );
    break;
  default:
    while (usacConfigExtLength[confExtIdx]--) {
      tmp;
  }
```

ISO/IEC 23008-3 add new syntax element “personalizationMapping”:

```
personalizationMapping( ) {
  mapsToContentFlag;
  shortUuidPresent;
  uuidPresent;
  mae groupPresetID( );
  usacConfigExtLength[confExtIdx]--;
  if (shortUuidPresent) {
    shortUuid;
    usacConfigExtLength[confExtIdx]--;
  }
  if (uuidPresent) {
    uuid;
    usacConfigExtLength[confExtIdx] −= 2;
  }
  if (usacConfigExtLength[confExtIdx] != 0) {
    numSwitchGroups
    for ( swgrp=0; swgrp < numSwitchGroups; swgrp++) {
      mae_SwitchGroupID
      mae_activeGroupID
    }
    numGroups
    for ( grp=0; grp < numGroups; grp++) {
      mae_groupID
      isEnabled
      hasDefaultAzimuth
      hasDefaultElevation
      hasDefaultGain
      if (!hasDefaultAzimuth) {
        groupAzOffset
      }
      if (!hasDefaultElevation) {
        groupEIOffset
      }
      if (!hasDefaultGain) {
        groupGain
      }
    }
  }
  ByteAlign( )
}
```

### Semantics:

mapsToContentFlag (1 Bit, bslbf) shall be set to one if the bitstream represents a representation of an interactive MPEG-H 3D Audio Scene. Otherwise, it shall be set to zero.
shortUuidPresent (1 Bit, bslbf) shall be set to one if the current configuration extension contains a shortUuid. Otherwise, it shall be set to zero.
uuidPresent (1 Bit, bslbf) shall be set to one if the current configuration extension contains a uuid. Otherwise, it shall be set to zero.
shortUuid (8 Bit, uimsbf) shall be set to the short content UUID (Universally Unique Identifier) of the encoded content.
uuid (16 Bit, uimsbf) shall be set to the UUID of the encoded content.
mae groupPresetID (5 Bit, uimsbf) shall correspond to the
mae_groupPresetID, as defined in ISO/IEC 23008-3, to which the current stream maps if the maps ToContentFlag is set. Otherwise it shall be set to 0.
numSwitchGroups (5 Bit, uimsbf) shall signal the number of switch groups with a non-default configuration. All switch groups that are not listed here, but are present in the MPEG-H 3D Audio bitstream, shall be in the default state as determined either by the switch group itself or the referenced preset above.
mae_switchGroupID[i] (5 Bit, uimsbf) shall correspond to the mae_switchGroupID of the corresponding mae_groupPresetID, as defined in ISO/IEC 23008-3, to which the current stream maps.
mae_activeSwitchGroupID[i] (7 Bit, uimsbf) shall map to the active mae switchGroupMemberID (selected for playback), which is part of the mae_switchGroupID[i].
numGroups (7 Bit,uimsbf) shall signal the number of groups with a non-default configuration (A switch group may be defined so as to contain a list of groups where only one group can be active at a time, e.g. the language of the main dialogue). All groups that are not listed here, but are present in the MPEG-H 3D Audio bitstream, shall be in the default state as determined either by the group itself or the referenced preset.
mae_GroupID[i] (7 Bit, uimsbf) shall correspond to the mae_groupID, as defined in ISO/IEC 23008-3, for which we are signalling a non-default configuration.
isEnabled[i] (1 Bit, bslbf) shall signal whether the referenced group is enabled or not.
hasDefaultAzimuth[i] (1 Bit, bslbf) shall signal whether the referenced group has its default azimuth value or not.
hasDefaultElevation[i] (1 Bit, bslbf) shall signal whether the referenced group has its default elevation value or not.
hasDefaultGain[i] (1 Bit, bslbf) shall signal whether the referenced group has its default gain value or not.
groupAzOffset[i] (8 Bit, uimsbf) shall signal the value of the azimuth property for the referenced group if hasDefaultAzimuth=False.
groupElOffset[i] (6 Bit, uimsbf) shall signal the value of the elevation property for the referenced group if hasDefaultElevation=False.
groupGain[i] (8 Bit, uimsbf) shall signal the value of the gain property for the referenced group if hasDefaultGain=False.
Configuration Extension and MHAS Packet to signal available Downmix personalization for MPEG-H 3D Audio

Depending on the standardization process, the personalization information might be transmitted in one of the following ways:
as MHAS packet (exclusive),
as Configuration Extension (exclusive),
or as Configuration Extension and as MHAS packet.

### Potential Example of Configuration Extension for MPEG-H 3D Audio

Add “personalizationMapping” (as described above) to ISO/IEC 23008-3 and extend Table 27 as follows:

```
case ID_CONFIG_EXT_STREAM_ID:
  CompatibleProfileLevelSet( );
  break;
case ID_CONFIG_EXT_PERSONALIZATION_MAPPING:
  personalizationMapping( );
  break;
default:
  while (usacConfigExtLength[confExtIdx]--) {
    tmp;
  }
```

### Potential Example of MHAS Packet for MPEG-H 3D Audio

1. Extend Table 223 of ISO/IEC 23008-3 with a new line:
   MHASPacketType: PACTYP_PERSONALIZATION_MAPPING
   Value: 20
   along with a matching description of the new PACTYP.
2. Extend Table 220 of ISO/IEC23008-3 with:
   case PACTYP_PERSONALIZATION_MAPPING:
   personalizationMapping ( )
   break;

### Potential Example of Transport Format Signalling (Format of Manifest File According to One Example)

A packager (e.g. streaming server device 200) can use the above bitstream signalling (e.g. side information with configuration information and/or capacity information) to add a respective mapping to manifest files (e.g. a DASH-MPD). This allows the client (e.g. 100-100e, 400-400e) to make a meaningful selection when switching from MPEG-H 3D Audio to Extended HE-AAC, taking into account the current user interactivity state. Furthermore, when switching back to MPEG-H 3D Audio, the client/decoder can automatically generate User Interaction Packets, a concept already available in MPEG-H 3D Audio, to select the correct combination of “Preset”, “Switch Group”, and “Group” elements, based on the novel USAC Extension Configuration.

A new signaling (e.g. configuration information) e.g. on MPD (Media Presentation Description) level (manifest, part of the side information 16) would for example be a novel Supplementary Property Descriptor (schemeldUri=“urn: mpeg: preselection-set-switching: 2021”), which may signals that a client can seamlessly switch from a given Preselection/AdaptationSet to a different Preselection/AdaptationSet. E.g., a client can seamlessly switch from a Preselection “p1” (MPEG-H 3D Audio) to a second AdaptationSet (Extended HE-AAC) “a2” while preserving (a subset) of the selected personalization options.

Furthermore, for example a new optional tag ‘streamId’ could also be added to the AdaptationSet tag. This could be referenced by the CODEC to signal matching external streams on manifest file level.

```
<Period>
  <AdaptationSet id=″a1″ codecs=″mhm1.0×12″ mimeType=″audio/mp4″
audioSamplingRate=″48000″ lang=″de″ segmentAlignment=″true″ startsWithSAP=″1″
treamId=″1″>
      <Role schemeIdUri=″urn:mpeg:dash:role:2011″ value=″main″/>
      <SupplementaryProperty schemeIdUri=″urn:mpeg:dash:preselection:2016″
/>
      <SegmentTemplate timescale=″48000″ media=″mpeghaudio/$Time$.m4s″
initialization=″mpeghaudio/init.mp4″>
        <SegmentTimeline>
          ...
        </SegmentTimeline>
      </SegmentTemplate>
      <Representation id=″m1″ bandwidth=″768000″>
        <AudioChannelConfiguration schemeIdUri=″urn:mpeg:mpegB:cicp:Channel
Configuration″ value=″19″/>
      </Representation>
      <Preselection id=″p1″ codecs=″mhm1.0×12″ tag=″1″ preselectionComponents=
″a1″ audioSampling Rate=″48000″ lang=″de″>
        <Role schemeIdUri=″urn:mpeg:dash:role:2011″ value=″main″/>
        <SupplementaryProperty schemeIdUri=″urn:mpeg:preselection-set-switching:
2021″ value=″a2″/>
        <AudioChannelConfiguration schemeIdUri=″urn:mpeg:mpegB:cicp:Channel
Configuration″ value=″19″/>
      </Preselection>
      <Preselection id=″p2″ codecs=″mhm1.0×12″ tag=″2″ preselectionComponents=
″a1″ audioSamplingRate=″48000″ lang=″de″>
        <Role schemeIdUri=″urn:mpeg:dash:role:2011″ value=″commentary″/>
        <SupplementaryProperty schemeIdUri=″urn:mpeg:preselection-set-
switching:2021″ value=″a3″/>
        <AudioChannelConfiguration schemeIdUri=″urn:mpeg:mpegB:cicp:
ChannelConfiguration″ value=″19″/>
      </Preselection>
  </Adaptation Set>
  <AdaptationSet id=″a2″ codecs=″mp4a.40.42″ mimeType=″audio/mp4″ audio
SamplingRate=″48000″ lang=″de″ segmentAlignment=″true″ startsWithSAP=″1″
streamId=″2″>
    <Role schemeIdUri=″urn:mpeg:dash:role:2011″ value=″main″/>
    <SupplementaryProperty schemeIdUri=″urn:mpeg:preselection-set-
switching:2021″ value=″p1″/>
    <SegmentTemplate timescale=″48000″ media=″xheaac_p1/$Time$.m4s″
initialization=″xheaac_p1/init.mp4″>
      <SegmentTimeline>
      ...
      </SegmentTimeline>
    </SegmentTemplate>
    <Representation id=″x1″ bandwidth=″24000″>
      <AudioChannelConfiguration schemeIdUri=″urn:mpeg:mpegB:cicp:Channel
Configuration″ value=″2″/>
    </Representation>
  </AdaptationSet>
  <AdaptationSet id=″a3″ codecs=″mp4a.40.42″ mimeType=″audio/mp4″ audio
SamplingRate=″48000″ lang=″de″ segmentAlignment=″true″ startsWithSAP=″1″
  streamId=″3″>
    <Role schemeIdUri=″urn:mpeg:dash:role:2011″ value=″commentary″/>
    <SupplementaryProperty schemeIdUri=″urn:mpeg:preselection-set-
switching:2021″ value=″p2″/>
    <SegmentTemplate timescale=″48000″ media=″xheaac_p2/$Time$.m4s″
initialization=″xheaac_p2/init.mp4″>
      <SegmentTimeline>
      ...
      </SegmentTimeline>
    </SegmentTemplate>
    <Representation id=″x2″ bandwidth=″24000″>
      <AudioChannelConfiguration schemeIdUri=″urn:mpeg:mpegB:cicp:Channel
Configuration″ value=″2″/>
    </Representation>
  </Adaptation Set>
</Period>
```

### Information for Rendering the UI

If a streaming client (e.g. 100-100e, 400-400e) starts decoding the NGA MPEG-H 3D Audio content, it has, e.g., access to the complete MPEG-H 3D Audio Scene Information (e.g. side information with configuration information and/or capacity information), which may contain the full set of available interactivity options (e.g. all presets, switch groups, position and gain interactivity). Therefore, a user might choose an advanced configuration, for example the “Dialog+” preset with an alternative language, by using the so called advanced UI options (or more in general personalization options). If no low bitrate representation (e.g. encoded using Extended HE-AAC) is available that is matching this personalization configuration, this again will lead to a compromised user experience during stream switching. In the above example, the language will change when switching to a low bitrate representation (low bitrate selectable version).

Therefore the current invention introduces a new MHAS packet and/or new Configuration Extension for MPEG-H 3D Audio to indicate which configurations are also available as low-bitrate, full-mix versions, either encoded as MPEG-H 3D Audio stream or as Extended HE-AAC stream. This information can be used by the playback device (e.g. 100-100e, 400-400e) for indication e.g. in the User Interface, or even for filtering the available UI options (e.g. personalization options) accordingly. It can also be used by the streaming client to select the best matching option, in case an exact match is not available, either automatically with or without informing the user, or giving options to the user for selection anticipation the need for a switch down.

### Available Switching Streams

To illustrate the invention, the following pages will give an example of a new MHAS packet type and/or Configuration Extension to indicate which configurations are also available as low-bitrate. Depending on the standardization process, the information might be transmitted in one of the following ways:
as MHAS packet (exclusive),
as Configuration Extension (exclusive),
or as Configuration Extension and as MHAS packet (combined).

### PACTYP_SWITCHING_STREAMS

To transmit the information via a new MHAS packet, the following changes could be performed:
1. Extend Table 223 of ISO/IEC 23008-3 with a new line: MHASPacketType: PACTYP_SWITCHING_STREAMS
Value: 19
along with a matching description of the new PACTYP.
2. Extend Table 220 of ISO/IEC23008-3 with:
   case PACTYP_SWITCHING_STREAMS:
   AvailableSwitchingStreams( );
   break;

Note: AvailableSwitchingStreams will be described in the following chapter.

### Configuration Extension

To transmit the information via a Configuration Extension, the following changes could be performed:
1. Extend table 77 of ISO/IEC 23008-3 with a new line:
   usacConfigExtType: ID_CONFIG_EXT_SWITCHING_STREAMS
   value: 7
   2. Extend table 24 of ISO/IEC23008-3 with:
case ID_CONFIG_EXT_SWITCHING_STREAMS:
   AvailableSwitchingStreams ( )
   break;

Note: AvailableSwitchingStreams will be described in the following chapter.

Syntax and Semantics of AvailableSwitchingStreams could be defined as follows:

| Syntax | No. of bits | Mnemonic |
|---|---|---|
| AvailableSwitchingStreams( ) | | |
| { | | |
| numStreams = escapedValue(3,8,16); | 3,11,27 | uimsbf |
| for ( stream = 0; stream < numStreams; stream++ ) { | | |
| manifestStreamId[stream]; | 8 | uimsbf |
| referencesPreset[stream]; | 1 | bslbf |
| reserved; | 7 | uimsbf |
| hasDefaultSettings[stream] = False | | |
| if (referencesPreset[stream]) { | | |
| groupPresetId[stream]; | 5 | uimsbf |
| hasDefaultSettings[stream]; | 1 | bslbf |
| reserved | 2 | |
| } | | |
| if (!hasDefaultSettings[stream]) { | | |
| numSwitchGroups[stream] | 5 | uimsbf |
| reserved | 3 | |
| for(swgrp=0; swgrp<numSwitchGroups[stream]; swgrp ++ ) | | |
| { | | |
| switchGroupId[stream][swgrp] | 5 | uimsbf |
| activeGroupId[stream][swgrp] | 7 | uimsbf |
| reserved | 4 | |
| } | | |
| numGroups[stream] | 8 | uimsbf |
| for ( grp=0; grp < numGroups[stream]; grp++ ) { | | |
| groupId[stream][grp] | 7 | uimsbf |
| isEnabled[stream][grp] | 1 | bslbf |
| hasDefaultAzimuth[stream][grp] | 1 | bslbf |
| hasDefaultElevation[stream][grp] | 1 | bslbf |
| hasDefaultGain[stream][grp] | 1 | bslbf |
| reserved | 5 | bslbf |
| if (!hasDefaultAzimuth[stream][grp]) { | | |
| groupAzOffset[stream][grp] | 8 | uimsbf |
| } | | |
| if (!hasDefaultElevation[stream][grp]) { | | |
| groupEIOffset[stream][grp] | 6 | uimsbf |
| reserved | 2 | |
| } | | |
| if (!hasDefaultGain[stream][grp]) { | | |
| groupGain[stream][grp] | 8 | uimsbf |
| } | | |
| } | | |
| } | | |
| } | | |
| } | | |

### Explanation of AvailableSwitchingStreams( )

numStreams: Signals the number of external streams that are available for switching. For each available stream a description follows.
manifestStreamId: A unique identifier for the external stream that is signaled in the manifest file. Note: In the example above this would reference the newly introduced streamId tag on the adaptationSet.
referencesPreset: This field specifies whether a preset is referenced next or not.
groupPresetId: If referencesPreset is True, this shall correspond to a mae_groupPresetId signaled in this stream.
hasDefaultSettings: A Boolean that signals whether the referenced preset is in the default state. If this is the case, no more details need to be signaled for this stream. Otherwise the differing configuration of the switch groups and groups follows.
numSwitchGroups: The number of switch group configurations that follow. Note, that this does not need to match the total number of switch groups signaled in this stream. All switch groups that are not listed here shall be in the default state as determined either by the switch group itself or the referenced preset above.
switchGroupId: This field specifies the mae_switchGroupID to which the following configuration applies.
activeGroupId: This field signals the selected group in the referenced switch group determined by switchGroupId.
numGroups: The number of group configurations that follow. Note, that this does not need to match the total number of groups signaled in this stream. All groups that are not listed here shall be in the default state as determined either by the group itself or the referenced preset above.
groupId: This field specifies the mae_groupID to which the following configuration applies.
isEnabled: This field specifies whether the group is turned on or off.
hasDefaultAzimuth: This field specifies whether the azimuth property has its signaled default value.
hasDefaultElevation: This field specifies whether the elevation property has its signaled default value.
hasDefaultGain: This fiels specifies whether the gain property has its signaled default value.
groupAzOffset: If hasDefaultAzimuth=False, this field signals the value of the azimuth property for the referenced group.
groupElOffset: If hasDefaultElevation=False, this field signals the value of the elevation property for the referenced group.
groupGain: If hasDefaultGain=False, this field signals the value of the gain property for the referenced group.

### Example

In the DASH example above, the MPEG-H 3D Audio adaptation set with id=“a1” contains the information which external streams are available for switching (either via a configuration extension or a new MHAS packet type as described above). The AvailableSwitchingStreams ( ) could look as follows:
numStreams=2
manifestStreamId=2
referencesPreset=True
groupPresetld=1
hasDefaultSettings=True
manifestStreamId=3
referencesPreset=True
groupPresetld=2
hasDefaultSettings=True

In this case the UI Manager will be able to display available low-bitrate alternatives for Presets 1 and 2, each in their default configuration.

### Session Audio Scene Information

In case the streaming session starts under bad network conditions, but the streaming client (e.g. 100-100e, 400-400e) expects that those conditions potentially recover, the client would first request a low bitrate, full mix version. However, in some examples, in this case there is no information available about the available personalization options, as they are only part of the Audio Scene Information (ASI) of the NGA MPEG-H 3D Audio content. Therefore, the current invention also introduces, in some examples, a new MHAS packet or new Configuration Extension for MPEG-H 3D Audio and Extended HE-AAC that includes the full Audio Scene Information (e.g. configuration information and/or capacity information) of the respective NGA content for the same streaming session. This enables the playback device (e.g. 100-100e, 400-400e) to already initialize the user interface and inform the user of all potentially available options, although none or not all of them might be currently selectable. Corresponding information needs to be added at the manifest and/or file format level respectively, to inform the streaming client during stream selection.

The latter scenario might also apply to fast tune-in scenarios. In this case the streaming client (e.g. 100-100e, 400-400e) intentionally selects the lowest bitrate version even under good network conditions to quickly fill the input buffer so that decoding and playback can start sooner. After some time the client then switches up to the full, high bitrate NGA version. If the full Audio Scene Information of the respective NGA content version is already available in the low bitrate, full-mix version, the client can already initialize the user interface during the start of playback, and not only later after it switched to the NGA version.

Very complex NGA scene authorings might lead to large ASI packets (e.g. very large configuration information and/or capacity information sent synchronously to the encoded version). As, in some examples, the ASI has to be repeated in each switching point in the bitstream that can lead to a substantial portion of the bitrate for low bitrate stream encodings. In those cases it might be beneficial to use a stripped version as Session ASI, for instance, removing alternative language label versions to reduce the size of the ASI.

### Configuration Extension for Extended HE-AAC:

ISO/IEC 23003-3 Table 27 could be extended as follows and with the following semantics:

```
case ID_CONFIG_EXT_STREAM_ID:
  streamId( );
  break;
case ID_CONFIG_EXT_AUDIOSCENE_INFO_MAPPING:
  mae_AudioSceneInfo( );
  break;
default:
  while (usacConfigExtLength[confExtIdx]--) {
    tmp;
  }
```

### Semantics:

mae_AudioSceneInfo (defined in ISO/IEC 23008-3) shall be used to transmit the AudioSceneInfo structure of the non-downmixed representation in a multi stream switching environment.

### Configuration Extension for MPEG-H 3D Audio:

ISO/IEC 23008-3 Table 27 could be extended as follows and with the following semantics:

```
case ID_CONFIG_EXT_STREAM_ID:
  CompatibleProfileLevelSet( );
  break;
case ID_CONFIG_EXT_AUDIOSCENE_INFO_MAPPING::
  mae_AudioSceneInfo( );
  break;
default:
  while (usacConfigExtLength[confExtIdx]--) {
    tmp;
  }
```

### Semantics:

10-mae_AudioSceneInfo (transmitted within the ID_CONFIG_EXT_AUDIOSCENE_INFO_MAPPING configuration extension) shall be used to transmit the most complex AudioSceneInfo structure in a multi stream switching environment.
   The Following could be Done to Define the MHAS Packet for MPEG-H 3D Audio:
1. Extend Table 223 of ISO/IEC 23008-3 with a new line: MHASPacketType: PACTYP AUDIOSCENE_INFO_MAPPING Value: 21 along with a matching description of the new PACTYP.
2. Extend Table 220 of ISO/IEC23008-3 with: case PACTYP AUDIOSCENE_INFO_MAPPING: mae_AudioSceneInfo ( ) break;
   Compliance with Legacy Systems

In some situations, there may be two different classes of audio codecs, NGA and Legacy. NGA (Next-Generation Audio) may be comprised of objects and side information (e.g. configuration information). Objects can be rendered into speaker-layouts, controlled by the client device (e.g. 100-100e, 400-400e). Personalization information allows to manipulate objects, controlled by the client device. NGA typically requires a higher (minimum) bitrate than Legacy, as there are more audio signals to encode. Legacy codecs can only operate on channels (speaker-layouts, see above). Legacy codecs are very efficient at compression, but lack interactivity and personalization information. The present technique describes a method how NGA and Legacy can be operated in a streaming environment (e.g. DASH) in a way that allows the streaming client device to switch between codec classes with minimal impact on the user experience. Variations of NGA that are appropriate for the use-case are rendered into one specific channel-based version each. Metadata (e.g. in the side information 16, and more in particular in the configuration information) may be applied to identify the (two-way) relationship between channel-based variation and original NGA. This allows the streaming client device to transition between NGA and Legacy

### Variants

Some variants and/or additional or alternative aspects are here discussed.

The implementation in hardware or in software may be performed using a digital storage medium, for example cloud storage, a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some examples according to the invention comprise a data carrier having electronically readable control signals, which are capable of cooperating with a programmable computer system, such that one of the methods described herein is performed.

Generally, examples of the present invention may be implemented as a computer program product with a program code, the program code being operative for performing one of the methods when the computer program product runs on a computer. The program code may for example be stored on a machine-readable carrier.

Other examples comprise the computer program for performing one of the methods described herein, stored on a machine-readable carrier. In other words, an example of the method is, therefore, a computer program having a program code for performing one of the methods described herein, when the computer program runs on a computer.

A further example of the methods is, therefore, a data carrier (or a digital storage medium, or a computer-readable medium) comprising, recorded thereon, the computer program for performing one of the methods described herein. A further example is, therefore, a data stream or a sequence of signals representing the computer program for performing one of the methods described herein. The data stream or the sequence of signals may for example be configured to be transferred via a data communication connection, for example via the Internet. A further example comprises a processing means, for example a computer, or a programmable logic device, configured to or adapted to perform one of the methods described herein. A further example comprises a computer having installed thereon the computer program for performing one of the methods described herein.

In some examples, a programmable logic device (for example a field programmable gate array) may be used to perform some or all of the functionalities of the methods described herein. In some examples, a field programmable gate array may cooperate with a microprocessor in order to perform one of the methods described herein. Generally, the methods are preferably performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A streaming client device, comprising:
a communication interface configured to receive a bitstream from a streaming server device, the bitstream comprising
an encoded audio signal according to an encoded audio signal version selected among a plurality of selectable encoded audio signal versions, each of the plurality of selectable encoded audio signal versions comprising at least one personalization audio option among a plurality of personalization audio options which is an option on an audio attribute which characterizes the particular selectable encoded audio signal version; and
side information comprising:
configuration information indicating the plurality of selectable personalization audio options for each of the selectable encoded audio signal versions; and
capacity information indicating capacity required, by each of the plurality of selectable encoded audio signal versions, by an external resource, for transmitting the encoded audio signal, wherein the external resource comprises, or is provided by, a communication network between the streaming server device and the streaming client device, wherein the external resource has a state which is a bandwidth at disposal of the transmission of the bitstream, wherein the capacity required by each selectable encoded audio signal version is a bitrate;
a personalization unit configured to define a personalization by performing a restriction to one single preferred version for each potential state from all the capacity-matching encoded audio selectable versions, by choosing, for each of a plurality of potential states of the external resource, the preferred encoded audio signal version among the plurality of selectable encoded audio signal versions, based on both the capacity information and the configuration information, so that:
for certain bandwidth(s), a particular encoded audio signal version is the preferred encoded audio signal version; and
for different bandwidth(s), a different encoded audio signal version is the preferred encoded audio signal version;
a selector configured to perform a selection of a selected encoded audio signal version based on a current state of the external resource and the personalization in such a way that the selected encoded audio signal version is the preferred encoded audio signal version for the current state of the external resource, so that the capacity required by the selected encoded audio signal version matches the current state of the external resource, so that the selection is not only based on the particular capacity required by each selectable encoded audio signal versions, but also on the personalization,
wherein the communication interface is configured to send, to the streaming server device, a request of providing the encoded audio signal according to the selected encoded audio signal version; and
a decoder configured to decode the received encoded audio signal or a transcoder configured to transcode the received encoded audio signal into another bitstream.

2. The streaming client device of claim 1, wherein at least one selectable encoded audio signal version comprises at least one locally deactivatable personalization audio option, wherein the streaming client device is configured to locally perform a second selection on the at least one locally deactivatable personalization audio option to locally select among activating and deactivating the at least one locally deactivatable personalization audio option, wherein the side information indicates that the at least one locally deactivatable personalization audio option is deactivatable.

3. The streaming client device of claim 1, wherein at least one selectable encoded audio signal version comprises at least two alternative personalization audio options which are alternative with each other, wherein the streaming client device is configured to perform a second selection among the two alternative personalization audio options to locally selectively activate one of the at least two alternative personalization audio options while locally deactivating the other(s) of the at least two alternative personalization audio options, wherein the side information indicates that the at least two alternative personalization audio options are alternative with each other.

4. The streaming device of claim 3, wherein the plurality of selectable encoded audio signal versions comprises:
a first selectable encoded audio signal version comprising at least a first alternative personalization audio option and a second alternative personalization audio option alternative to the second personalization audio option, the first selectable encoded audio signal version requiring a first capacity at a first potential state of the external resource; and
a second selectable encoded audio signal version requiring a second capacity at a second potential state of the external resource, the second capacity being lower than the first capacity, wherein the second selectable encoded audio signal version comprises the first alternative personalization audio option but not the second alternative personalization audio option,
wherein the selector is configured, in case the personalization requires the first alternative personalization audio option, to:
in case of the current state of the external resource matching the first potential state of the external resource, select the first selectable encoded audio signal version, and the first alternative personalization audio option is locally chosen and decoded, rendered or transcoded, while the second alternative personalization audio option is locally deactivated;
in case of the current state of the external resource matching the second potential state of the external resource, select the second selectable encoded audio signal version.

5. The streaming client device of claim 4, wherein the first selectable encoded audio signal version comprises more alternative personalization audio options than the second selectable encoded audio signal version.

6. The streaming device of claim 4, wherein the first alternative personalization audio option is defined on a first numerical range comprising a second numerical range on which the second alternative personalization audio option is defined.

7. The streaming device of claim 4, wherein the first selectable encoded audio signal version comprises the same alternative personalization audio option(s) of the second selectable encoded audio signal version, plus additional alternative personalization audio options.

8. The streaming client device of claim 1, wherein the personalization unit is configured to define, for each potential state of the external resource, the personalization, through an evaluation of at least one evaluation condition on at least one personalization audio option, or a set or combination of personalization audio options, for each selectable encoded audio signal version, the evaluation providing at least one ordering to sort the selectable encoded audio signal versions according to a ranking, so as to choose the highest-ordered selectable encoded audio signal version as the preferred encoded audio signal version.

9. The streaming client device of claim 8, wherein the at least one evaluation condition comprises at least a first evaluation condition on at least one first personalization audio option, or a first set or combination of personalization audio options, and at least one second evaluation condition on at least one second personalization audio option, or a second set or combination of personalization audio options, so as to define at least one first ordering to sort the selectable encoded audio signal versions according to the first evaluation condition, and one second ordering to sort the selectable encoded audio signal versions according to the second evaluation condition, so as to choose the preferred encoded audio signal version based on at least one of the first ordering and the second ordering.

10. The streaming client device of claim 9, wherein the first evaluation condition is dominant, and the second evaluation condition is secondary, so as to define the preferred encoded audio signal version primarily based on the first ordering, and, in case of parity of ranking between different first-ordering-highest-ranking selectable encoded audio signal versions, to define as the preferred encoded audio signal version the first-ordering-highest-ranking selectable encoded audio signal version which comprises the highest ranking in the second ordering.

11. The streaming client device of claim 8, configured, in case the personalization input changes in such a way that at least one evaluation condition is still fulfilled by a currently locally deactivated at least one alternative personalization audio option, to maintain the selected version without sending a request to the streaming server device, and to locally change the second selection so as to fulfil the at least one evaluation condition.

12. The streaming client device of claim 1, wherein at least one personalization audio option comprises at least one of the following options: dialog of the encoded audio signal, gain level, position data, and audio object selection.

13. The streaming client device of claim 3, wherein the selector is configured to change the selected audio signal version based on the current state of the external resource, so that the request of the selected audio signal version is updated during the reception of the bitstream, and to subsequently obtain the encoded audio signal according to the updated selected audio signal version, the streaming client device being configured to locally perform a second selection in case a new personalization is required and in case the new personalization is satisfied by an alternative personalization audio option which is currently received.

14. The streaming client device of claim 1, wherein the encoded audio signal is segmented in a plurality of segments, wherein each segment is interchangeable with a respective segment of an encoded audio signal of at least one different encoded audio signal version.

15. The streaming client device of claim 1, configured to condition the selection performed by the selector and/or the personalization defined by the personalization unit by a capacity requirement conditioning information so that the selected audio signal version requires a capacity following a pre-defined data plan.

16. The streaming client device of claim 1, wherein the encoded audio signal is according to the codec MPEG-H 3D Audio, wherein other selectable encoded audio signal versions are according to the codec MPEG-H 3D Audio, the bitstream and/or side information being embedded according to MPEG-H 3D Audio.

17. The streaming client device of claim 1, wherein the encoded audio signal is according to the codec MPEG-H 3D Audio and/or MPEG-D USAC, Extended HE-AAC, and the other selectable encoded audio signal versions are encoded either using MPEG-H 3D Audio or MPEG-D USAC, Extended HE-AAC, wherein the bitstream or side information is according to MPEG-H 3D Audio or MPEG-D USAC, Extended HE-AAC.

18. A streaming server device, comprising:
a communication interface configured to:
transmit a bitstream to a streaming client device, the bitstream being segmented according to a plurality of segments and comprising an encoded audio signal and side information, the side information comprising:
configuration information indicating a plurality of selectable personalization audio options for each selectable encoded audio signal version of a plurality of encoded audio signal versions, wherein the configuration information indicates a set of personalization audio options offered by the other encoded audio signal versions; and
capacity information indicating capacity required, by each of the plurality of selectable encoded audio signal versions, by an external resource, for transmitting the encoded audio signal, wherein the external resource comprises, or is provided by, a communication network between the streaming server device and the streaming client device, wherein the external resource has a state which is a bandwidth at disposal of the transmission of the bitstream, wherein the capacity required by each selectable encoded audio signal version is a bitrate;
receive requests of a selected encoded audio signal version of the bitstream, and transmit the bitstream according to the selected encoded audio signal version starting from a subsequent segment, wherein each of the encoded audio signal versions requires a predetermined capacity and offers at least one personalization audio option which is an option on an audio attribute which characterizes the particular selected encoded audio signal version, wherein the capacity is a bitrate; and
a content preparation device to embed, to each encoded audio signal version, side information comprising capacity information indicating a capacity required for transmission of other encoded audio signal versions and configuration information indicating the at least one personalization audio option offered by the other encoded audio signal versions.

19. The streaming server device of claim 18, wherein the encoded audio signal is according to the codec MPEG-H 3D Audio and/or MPEG-D USAC, Extended HE-AAC, wherein the encoded audio signal version is according to MPEG-H 3D Audio, and the other selectable encoded audio signal versions are encoded either using MPEG-H 3D Audio or MPEG-D USAC, Extended HE-AAC, wherein the bitstream or side information is according to MPEG-H 3D Audio or MPEG-D USAC, Extended HE-AAC.

20. A streaming method, comprising:
receiving a bitstream from a streaming server device, the bitstream comprising:
an encoded audio signal according to an encoded audio signal version selected among a plurality of selectable encoded audio signal versions, each of the plurality of selectable encoded audio signal versions comprising at least one personalization audio option among a plurality of personalization audio options which is an option on an audio attribute which characterizes the particular selectable encoded audio signal version, and
side information comprising:
configuration information indicating the plurality of selectable personalization audio options; and
capacity information indicating capacity required, by each of the plurality of selectable encoded audio signal versions, by an external resource, for transmitting the encoded audio signal, wherein the external resource comprises, or is provided by, a communication network between the streaming server device and the streaming client device, wherein the external resource has a state which is a bandwidth at disposal of the transmission of the bitstream, wherein the capacity required by each selectable encoded audio signal version is a bitrate;
defining a personalization by performing a restriction to one single preferred version for each potential state from all the capacity-matching encoded audio selectable versions by choosing, for each of a plurality of potential states of the external resource, a preferred encoded audio signal version among the plurality of selectable encoded audio signal versions, based on both the capacity information and the configuration information so that:
for certain bandwidth(s), a particular encoded audio signal version is the preferred encoded audio signal version; and
for different bandwidth(s), a different encoded audio signal version is the preferred encoded audio signal version;
performing a selection of a selected encoded audio signal version based on a current state of the external resource and the personalization in such a way that the selected encoded audio signal version is the preferred encoded audio signal version for the current state of the external resource, so that the capacity required by the selected encoded audio signal version matches the current state of the external resource, so that the selection is not only based on the particular capacity required by each selectable encoded audio signal versions, but also on the personalization,
sending, to the streaming server device, a request of providing the encoded audio signal according to the selected encoded audio signal version; and
providing the received encoded audio signal to a decoder or a transcoder.

21. A streaming method for transmitting a bitstream to a streaming client device, the bitstream being segmented according to a plurality of segments and comprising an encoded audio signal and side information, the side information comprising:
configuration information indicating a plurality of selectable personalization audio options for each selectable encoded audio signal version of a plurality of encoded audio signal versions, wherein the configuration information indicates a set of personalization audio options offered by the other encoded audio signal versions; and
capacity information indicating capacity required, by each of the plurality of selectable encoded audio signal versions, by an external resource, for transmitting the encoded audio signal, wherein the external resource comprises, or is provided by, a communication network between the streaming server device and the streaming client device, wherein the external resource has a state which is a bandwidth at disposal of the transmission of the bitstream, wherein the capacity required by each selectable encoded audio signal version is a bitrate;
the method comprising:
receiving requests of a selected encoded audio signal version of the bitstream, and transmit the bitstream according to the selected encoded audio signal version starting from a subsequent segment, wherein each of the encoded audio signal versions requires a predetermined capacity and offers at least one personalization audio option which is an option on an audio attribute which characterizes the particular selected encoded audio signal version, wherein the capacity is a bitrate; and
the method comprising embedding, to each encoded audio signal version, side information comprising capacity information indicating a capacity required for transmission of other encoded audio signal versions and configuration information indicating the at least one personalization audio option offered by the other encoded audio signal versions.
